(19) United States
(12) Patent Application Publication
(10) Pub. No.: US 2018/0053955 A1
(43) Pub. Date: Feb. 22, 2018

(54) Membrane Assemblies, Electrode Assemblies, Membrane-Electrode Assemblies and Electrochemical Cells and Liquid Flow Batteries Therefrom

(71) Applicant: 3M INNOVATIVE PROPERTIES COMPANY, St. Paul, MN (US)

(72) Inventors: Brian T. Weber, St. Paul, MN (US); Kazuki Noda, Tokyo (JP); Onur S. Yordem, St. Paul, MN (US); Gregory M. Haugen, Edina, MN (US); Bharat R. Acharya, Woodbury, MN (US); Andrew T. Haug, Woodbury, MN (US); Shunsuke Suzuki, Tokyo (JP); Brett J. Sitter, Cottage Grove, MN (US)

(21) Appl. No.: 15/556,194

(22) PCT Filed: Mar. 22, 2016
(86) PCT No.: PCT/US2016/023522

§ 371 Date: Sep. 6, 2017

Related U.S. Application Data
(60) Provisional application No. 62/137,504, filed on Mar. 24, 2015.

(51) Int. Cl. H01M 8/1004; H01M 4/86

(52) U.S. Cl. CPC H01M 8/1004; H01M 4/8605; H01M 4/0407; H01M 4/8673; H01M 4/8652

(57) ABSTRACT

The present disclosure relates to membrane assemblies, electrode assemblies and membrane-electrode assemblies; and electrochemical cells and liquid flow batteries produced therefrom. The disclosure further provides methods of making the membrane assemblies, electrode assemblies and membrane-electrode assemblies. The membrane assemblies includes an ion exchange membrane and at least one microporous protection layer. The electrode assemblies includes a porous electrode and a microporous protection layer. The membrane-electrode assembly includes an ion exchange membrane, at least one microporous protection layer and at least one porous electrode. The microporous protection layer includes a resin and at least one of an electrically conductive particulate and a non-electrically conductive particulate. The ratio of the weight of the resin to total weight of particulate is from about 1/99 to about 10/1. The resin may be at least one of an ionic resin and a non-ionic resin.

### FIELD

The present invention generally relates to assemblies useful in the fabrication of electrochemical cells and batteries. In particular, the present invention relates to membrane assemblies, electrode assemblies and membrane-electrode assemblies; and electrochemical cells and liquid flow batteries produced therefrom. The disclosure further provides methods of making the membrane assemblies, electrode assemblies and membrane-electrode assemblies.

### BACKGROUND

Various components useful in the formation of electrochemical cells and redox flow batteries have been disclosed in the art. Such components are described in, for example, U.S. Pat. Nos. 5,648,184, 8,518,572 and 8,882,057.

### SUMMARY

In one embodiment, the present disclosure provides a membrane assembly for a liquid flow battery comprising:
an ion exchange membrane having a first surface and an opposed second surface;
a first microporous protection layer having a first surface and an opposed second surface; wherein the first surface of the ion exchange membrane is in contact with the first surface of the first microporous protection layer; and the first microporous protection layer comprises:
   a resin; and
   at least one of an electrically conductive particulate and a non-electrically conductive particulate, wherein the ratio of the weight of the resin to total weight of particulate is from about 1/99 to about 10/1.

In another embodiment, the present disclosure provides a membrane assembly for a liquid flow battery comprising:
an ion exchange membrane having a first surface and an opposed second surface;
a first microporous protection layer having a first surface and an opposed second surface;
   wherein the first surface of the ion exchange membrane is in contact with the first surface of the first microporous protection layer; and the first microporous protection layer comprises:
a resin; and
at least one of an electrically conductive particulate and a non-electrically conductive particulate, wherein the ratio of the weight of the resin to total weight of particulate is from about 1/99 to about 10/1.
a second microporous protection layer have a first surface and an opposed second surface; wherein the second surface of the ion exchange membrane is in contact with the first surface of the second microporous protection layer; and the second microporous protection layer comprises:
a resin; and
at least one of an electrically conductive particulate and a non-electrically conductive particulate, wherein the ratio of the weight of the resin to total weight of particulate is from about 1/99 to about 10/1.

In another embodiment, the present disclosure provides an electrode assembly for a liquid flow battery comprising:
a porous electrode having a first surface and an opposed second surface;
a first microporous protection layer having a first surface and an opposed second surface; wherein the first surface of the porous electrode is proximate the second surface of the first microporous protection layer; and the first microporous protection layer comprises:
   a resin; and
   at least one of an electrically conductive particulate and a non-electrically conductive particulate, wherein the ratio of the weight of the resin to total weight of particulate is from about 1/99 to about 10/1.

In another embodiment, the present disclosure provides a membrane-electrode assembly for a liquid flow battery comprising:
an ion exchange membrane having a first surface and an opposed second surface;
a first and second microporous protection layer each having a first surface and an opposed second surface; wherein the first surface of the ion exchange membrane is in contact with the first surface of the first microporous protection layer and the second surface of the ion exchange membrane is in contact with the first surface of the second microporous protection layer; and the first and second first microporous protection layers comprise:
   a resin; and
   at least one of an electrically conductive particulate and a non-electrically conductive particulate, wherein the ratio of the weight of the resin to total weight of particulate is from about 1/99 to about 10/1; and
a first and second porous electrode each having a first surface and an opposed second surface; wherein the first surface of the first porous electrode is proximate to the second surface of the first microporous protection layer and the first surface of the second porous electrode is proximate to the second surface of the second microporous protection layer.

In another embodiment the present disclosure provides an electrochemical cell for a liquid flow battery comprising a membrane assembly according to any one of the membrane assemblies of the present disclosure.

In another embodiment the present disclosure provides an electrochemical cell for a liquid flow battery comprising an electrode assembly according to any one of the electrode assemblies of the present disclosure.

In another embodiment the present disclosure provides an electrochemical cell for a liquid flow battery comprising a membrane-electrode assembly according to any one of the membrane-electrode assemblies of the present disclosure.

In another embodiment the present disclosure provides a liquid flow battery comprising a membrane assembly according to any one of the membrane assemblies of the present disclosure.

In another embodiment the present disclosure provides a liquid flow battery comprising an electrode assembly according to any one of the electrode assemblies of the present disclosure.

In another embodiment the present disclosure provides a liquid flow battery comprising a membrane-electrode assembly according to any one of the membrane-electrode assemblies of the present disclosure.

In yet another embodiment, the preset disclosure provides any one of the previous embodiments, wherein the resin is at least one of an ionic resin and a non-ionic resin.

### BRIEF DESCRIPTION OF THE DRAWINGS

FIG. 1A is a schematic cross-sectional side view of an exemplary membrane assembly according to one exemplary embodiment of the present disclosure.

FIG. 1B is a schematic cross-sectional side view of an exemplary membrane assembly according to one exemplary embodiment of the present disclosure.

FIG. 2 is a schematic cross-sectional side view of an exemplary electrode assembly according to one exemplary embodiment of the present disclosure.

FIG. 3 is a schematic cross-sectional side view of an exemplary membrane-electrode assembly according to one exemplary embodiment of the present disclosure.

FIG. 4 is a schematic cross-sectional side view of an exemplary electrochemical cell according to one exemplary embodiment of the present disclosure.

FIG. 5 is a schematic cross-sectional side view of an exemplary electrochemical cell stack according to one exemplary embodiment of the present disclosure.

FIG. 6 is a schematic view of an exemplary single cell liquid flow battery according to one exemplary embodiment of the present disclosure.

Repeated use of reference characters in the specification and drawings is intended to represent the same or analogous features or elements of the disclosure. The drawings may not be drawn to scale. As used herein, the word “between”, as applied to numerical ranges, includes the endpoints of the ranges, unless otherwise specified. The recitation of numerical ranges by endpoints includes all numbers within that range (e.g. 1 to 5 includes 1, 1.5, 2, 2.75, 3, 3.80, 4, and 5) and any range within that range. Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

It should be understood that numerous other modifications and embodiments can be devised by those skilled in the art, which fall within the scope and spirit of the principles of the disclosure. All scientific and technical terms used herein have meanings commonly used in the art unless otherwise specified. The definitions provided herein are to facilitate understanding of certain terms used frequently herein and are not meant to limit the scope of the present disclosure. As used in this specification and the appended claims, the singular forms “a”, “an”, and “the” encompass embodiments having plural referents, unless the context clearly dictates otherwise. As used in this specification and the appended claims, the term “or” is generally employed in its sense including “and/or” unless the context clearly dictates otherwise.

Throughout this text, when a surface of one substrate is in “contact” with the surface of another substrate, there are no intervening layer(s) between the two substrates and at least a portion of the surfaces of the two substrates are in physical contact.

Throughout this text, if a surface of one substrate is “proximate” a surface of another substrate, the two surface are considered to be facing one another and to be in close proximity to one another, i.e. to be within less than 500 microns, less than 250 microns, less than 100 microns or even in contact with one another. However, there may be one or more intervening layers between the substrate surfaces.

### DETAILED DESCRIPTION

A single electrochemical cell, which may be used in the fabrication of a liquid flow battery (e.g. a redox flow battery), generally, include two porous electrodes, an anode and a cathode; an ion permeable membrane disposed between the two electrodes, providing electrical insulation between the electrodes and providing a path for one or more select ionic species to pass between the anode and cathode half-cells; anode and cathode flow plates, the former positioned adjacent the anode and the later positioned adjacent the cathode, each containing one or more channels which allow the anolyte and catholyte electrolytic solutions to contact and penetrate into the anode and cathode, respectively. The anode, cathode and membrane of the cell or battery will be referred to herein as a membrane-electrode assembly (MEA). In a redox flow battery containing a single electrochemical cell, for example, the cell would also include two current collectors, one adjacent to and in contact with the exterior surface of the anode flow plate and one adjacent to and in contact with the exterior surface of the cathode flow plate. The current collectors allow electrons generated during cell discharge to connect to an external circuit and do useful work. A functioning redox flow battery or electrochemical cell also includes an anolyte, anolyte reservoir and corresponding fluid distribution system (piping and at least one or more pumps) to facilitate flow of anolyte into the anode half-cell, and a catholyte, catholyte reservoir and corresponding fluid distribution system to facilitate flow of catholyte into the cathode half-cell. Although pumps are typically employed, gravity feed systems may also be used. During discharge, active species, e.g. cations, in the anolyte are oxidized and the corresponding electrons flow though the exterior circuit and load to the cathode where they reduce active species in the catholyte. As the active species for electrochemical oxidation and reduction are contained in the anolylte and catholyte, redox flow cells and batteries have the unique feature of being able to store their energy outside the main body of the electrochemical cell, i.e. in the anolyte. The amount of storage capacity is mainly limited by the amount of anolyte and catholyte and the concentration of active species in these solutions. As such, redox flow batteries may be used for large scale energy storage needs associated with wind farms and solar energy plants, for example, by scaling the size of the reservoir tanks and active species concentrations, accordingly. Redox flow cells also have the advantage of having their storage capacity being independent of their power. The power in a redox flow battery or cell is generally determined by the size and number of electrode-membrane assemblies along with their corresponding flow plates (sometimes referred to in total as a “stack”) within the battery. Additionally, as redox flow batteries are being designed for electrical grid use, the voltages must be high. However, the voltage of a single redox flow electrochemical cell is generally less than 3 volts (difference in the potential of the half-cell reactions making up the cell). As such, hundreds of cells are required to be connected in series to generate voltages great enough to have practical utility and a significant amount of the cost of the cell or battery relates to the cost of the components making an individual cell.

At the core of the redox flow electrochemical cell and battery is the membrane-electrode assembly (anode, cathode and ion permeable membrane disposed there between). The design of the MEA is critical to the power output of a redox flow cell and battery. Subsequently, the materials selected for these components are critical to performance. Materials used for the electrodes may be based on carbon, which provides desirable catalytic activity for the oxidation/reduction reactions to occur and is electrically conductive to provide electron transfer to the flow plates. The electrode materials may be porous, to provide greater surface area for the oxidation/reduction reactions to occur. Porous electrodes may include carbon fiber based papers, felts, and cloths. When porous electrodes are used, the electrolytes may penetrate into the body of the electrode, access the additional surface area for reaction and thus increase the rate of energy generation per unit volume of the electrode. Also, as one or both of the anolyte and catholyte may be water based, i.e. an aqueous solution, there may be a need for the electrode to have a hydrophilic surface, to facilitate electrolyte permeation into the body of a porous electrode. Surface treatments may be used to enhance the hydrophilicity of the redox flow electrodes. This is in contrast to fuel cell electrodes which typically are designed to be hydrophobic, to prevent moisture from entering the electrode and corresponding catalyst layer/region, and to facilitate removal of moisture from the electrode region in, for example, a hydrogen/oxygen based fuel cell.

Materials used for the ion permeable membrane are required to be good electrical insulators while enabling one or more select ions to pass through the membrane. These material are often fabricated from polymers and may include ionic species to facilitate ion transfer through the membrane. Thus, the material making up the ion permeable membrane may be an expensive specialty polymer. As hundreds of MEAs may be required per cell stack and battery, the ion permeable membrane may be a significant cost factor with respect to the overall cost of the MEA and the overall cost of a cell and battery. As it is desirable to minimize the cost of the MEAs, one approach to minimizing their cost is to reduce the volume of the ion permeable membrane used therein. However, as the power output requirements of the cell help define the size requirements of a given MEA and thus the size of the membrane, with respect to its length and width dimensions (larger length and width, generally, being preferred), it may only be possible to decrease the thickness of the ion permeable membrane, in order to decrease the cost of the MEA. However, by decreasing the thickness of the ion permeable membrane, a problem has been identified. As the membrane thickness has been decreased, it has been found that the relatively stiff fibers, e.g. carbon fibers, used to fabricate the porous electrodes, can penetrate through the thinner membrane and contact the corresponding electrode of the opposite half-cell. This causes detrimental localized shorting of the cell, a loss in the power generated by the cell and a loss in power of the overall battery. Thus, there is a need for improved membrane-electrode assemblies that can prevent this localized shorting while maintaining the required ion transport through the membrane without inhibiting the required oxidation/reduction reaction of the electrochemical cells and batteries fabricated therefrom.

The present disclosure provides MEAs having a new design that includes at least one microporous protection layer. The microporous protection layer protects the ion permeable membrane from puncture by the fibers of the electrode and thus prevents localized shorting that has been found to be an issue in other MEA designs. The MEAs with at least one microporous protection layer are useful in the fabrication of liquid flow, e.g. redox flow, electrochemical cells and batteries. Liquid flow electrochemical cells and batteries may include cells and batteries having a single half-cell being a liquid flow type or both half-cells being a liquid flow type. The microporous protection layer may be a component of a membrane assembly (MA) and/or an electrode assembly (EA) that are used to fabricate the MEAs. The present disclosure also includes liquid flow electrochemical cells and batteries containing MEAs that include at least one microporous layer. The present disclosure further provides methods of fabricating membrane assemblies, electrode assemblies and membrane-electrode assemblies useful in the fabrication of liquid flow electrochemical cells and batteries.

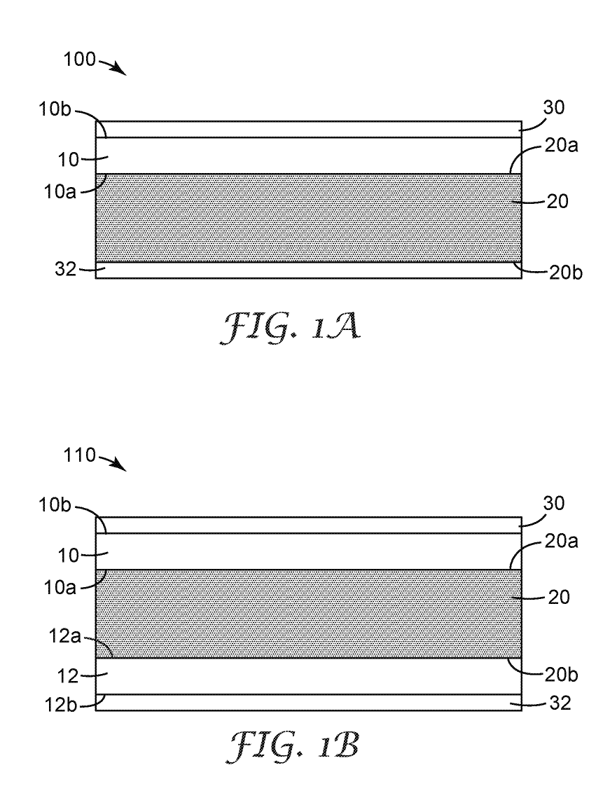

FIGS. 1A, 1B, 2 and 3 disclose a membrane assembly that includes at least one microporous protection layer, a membrane assembly that includes at least two microporous protection layers, an electrode assembly that includes at least one microporous protection layer and a membrane-electrode assembly that includes at least one microporous protection layer, respectively. In one embodiment of the present disclosure a membrane assembly includes a first microporous protection layer. FIG. 1A shows a schematic cross-sectional side view of membrane assembly 100, including an ion exchange membrane 20 having a first surface 20a and an opposed second surface 20b, a first microporous protection layer 10 having a first surface 10a and an opposed second surface 10b. First surface 20a of ion exchange membrane 20 is in contact with first surface 10a of first microporous protection layer 10. Membrane assembly 100 may further include optional release liner 30.

In another embodiment of the present disclosure a membrane assembly includes a first and second microporous protection layer. FIG. 1B shows a schematic cross-sectional side view of membrane assembly 110, including an ion exchange membrane 20 having a first surface 20a and an opposed second surface 20b, a first microporous protection layer 10 having a first surface 10a and an opposed second surface 10b and a second microporous protection layer 12 having a first surface 12a and an opposed second surface 12b. First surface 20a of ion exchange membrane 20 is in contact with first surface 10a of first microporous protection layer 10. Second surface 20b of ion exchange membrane 20 is in contact with first surface 12a of second microporous protection layer 12. Membrane assembly 110 may further include one or more optional release liners 30, 32. The optional release liners 30 and 32 may remain with the membrane assembly until it is used to fabricate a membrane-electrode assembly, in order to protect the outer surface of the microporous protection layer from dust and debris. The release liners may also provide mechanical support and prevent tearing of the microporous protection layer and/or marring of its surface, prior to fabrication of the membrane-electrode assembly. Conventional release liners known in the art may be used for optional release liners 30 and 32.

Another embodiment of the present disclosure includes an electrode assembly having a porous electrode and a first microporous protection layer. FIG. 2 shows a schematic cross-sectional side view of an electrode assembly 200 including a porous electrode 40 having a first surface 40a and an opposed second surface 40b, and a first microporous protection layer 10 having a first surface 10a and an opposed second surface 10b. In some embodiments, the first surface 40a of porous electrode 40 is proximate the second surface 10b of the first microporous protection layer 10. In some embodiments, the first surface 40a of porous electrode 40 is in contact with the second surface 10b of the first microporous protection layer 10. Electrode assembly 200 may further include one or more optional release liners 30, 32. The optional release liners 30 and 32 may remain with the electrode assembly until it is used to fabricate a membrane-electrode assembly, in order to protect the outer surfaces of the microporous protection layer and porous electrode from dust and debris. The release liners may also provide mechanical support and prevent tearing of the microporous protection layer and porous electrode and/or marring of their surfaces, prior to fabrication of the membrane-electrode assembly. Conventional release liners known in the art may be used for optional release liners 30 and 32.

The microporous protection layers of the present disclosure include a resin and at least one of an electrically conductive particulate and a non-electrically conductive particulate. Resins of microporous protection layer should allow the select ion(s) of the electrolytes to transfer through the microporous layer. This may be achieved by allowing the electrolyte to easily wet and absorb into a given microporous protection layer. The material properties, particularly the surface wetting characteristics of the microporous protection layer may be selected based on the type of anolyte and catholyte solution, i.e. whether they are aqueous based or non-aqueous based. As disclosed herein, an aqueous based solution is defined as a solution wherein the solvent includes at least 50% water by weight. A non-aqueous base solution is defined as a solution wherein the solvent contains less than 50% water by weight. In some embodiments, the resins of the microporous protection layer may be hydrophilic. This may be particularly beneficial when the microporous protection layers are to be used in conjunction with aqueous anolyte and/or catholyte solutions. In some embodiments the resin may have a surface contact angle with water, catholyte and/or anolyte of less than 90 degrees. In some embodiments, the resin may have a surface contact with water, catholyte and/or anolyte of between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees. In some embodiments, the resin of a first microporous protection layer and the resin of a second microporous protection layer are the same resins. In some embodiments, the resin of a first microporous protection layer and the resin of a second microporous protection layer are different resins.

The resin of the microporous protection layers of the present disclosure are polymer resin. Resin of the microporous protection layer may be an ionic resin or non-ionic resin. Ionic resin include polymer resin wherein a fraction of the repeat units are electrically neutral and a fraction of the repeat units have an ionic functional group, i.e. an ionic repeat unit. In some embodiments, the resin is an ionic resin, wherein the ionic resin has a mole fraction of repeat units having an ionic functional group of between about 0.005 and about 1. In some embodiments, the resin is a non-ionic resin, wherein the non-ionic resin has a mole fraction of repeat units having an ionic functional group of from less than about 0.005 to about 0. In some embodiments, the resin is a non-ionic resin, wherein the non-ionic resin has no repeat units having an ionic functional group. In some embodiments, the resin consist essentially of an ionic resin. In some embodiments, the resin consists essentially of a non-ionic resin. Resins of the microporous protection layer may include thermoplastic resins (including thermoplastic elastomer), thermoset resins (including glassy and rubbery materials) and combinations thereof. The resin may be a precursor resin containing one or more of monomer and oligomer which may be cured to form a microporous protection layer. The precursor resin may also contain dissolved polymer. The precursor resin may contain solvent which is removed prior to or after curing of the precursor resin. The resin may be in the form of a dispersion of resin particles, the solvent of the dispersion being removed to form the microporous protection layer. The resin may be dissolved in a solvent, the solvent being removed to form the microporous protection layer. Useful thermoplastic resins include, but are not limited to, at least one of polyethylene, e.g. high molecular weight polyethylene, high density polyethylene, ultra-high molecular weight polyethylene, polypropylene, e.g. high molecular weight polypropylene, chlorinated polyvinyl chloride, polytetrafluoroethylene (PTFE), e.g. high molecular weight PTFE, fluoropolymer, e.g. perfluorinated fluoropolymer and partially fluorinated fluoropolymer each of which may be semi-crystalline and/or amorphous, polyetherimides and polyketones. Useful thermoset resins include, but are not limited to, at least one of epoxy resin, phenolic resin, polyurethanes, urea-formadehyde resin and melamine resin. Ionic resin include, but are not limited to, ion exchange resins, ionomer resins and combinations thereof. Ion exchange resins may be particularly useful.

As broadly defined herein, ionic resin include resin wherein a fraction of the repeat units are electrically neutral and a fraction of the repeat units have an ionic functional group. In some embodiments, the ionic resin has a mole fraction of repeat units with ionic functional groups between about 0.005 and 1. In some embodiments, the ionic resin is a cationic resin, i.e. its ionic functional groups are negatively charged and facilitate the transfer of cations, e.g. protons, optionally, wherein the cationic resin is a proton cationic resin. In some embodiments, the ionic resin is an anionic exchange resin, i.e. its ionic functional groups are positively charged and facilitate the transfer of anions. The ionic functional group of the ionic resin may include, but is not limited, to carboxylate, sulphonate, sulfonamide, quaternary ammonium, thiuronium, guanidinium, imidazolium and pyridinium groups. Combinations of ionic functional groups may be used in an ionic resin.

Ionomer resin include resin wherein a fraction of the repeat units are electrically neutral and a fraction of the repeat units have an ionic functional group. As defined herein, an ionomer resin will be considered to be a resin having a mole fraction of repeat units having ionic functional groups of no greater than about 0.15. In some embodiments, the ionomer resin has a mole fraction of repeat units having ionic functional groups of between about 0.005 and about 0.15, between about 0.01 and about 0.15 or even between about 0.3 and about 0.15. In some embodiments the ionomer resin is insoluble in at least one of the anolyte and catholyte. The ionic functional group of the ionomer resin may include, but is not limited, to carboxylate, sulphonate, sulfonamide, quaternary ammonium, thiuronium, guanidinium, imidazolium and pyridinium groups. Combinations of ionic functional groups may be used in an ionomer resin. Mixtures of ionomer resins may be used. The ionomers resin may be a cationic resin or an anionic resin. Useful ionomer resin include, but are not limited to NAFION, available from DuPont, Wilmington, Del.; AQUIVION, a perfluorosulfonic acid, available from SOLVAY, Brussels, Belgium; FLEMION and SELEMION, fluoropolomer ion exchange resin, from Asahi Glass, Tokyo, Japan; FUMASEP ion exchange resin, including FKS, FKB, FKL, FKE cation exchange resins and FAB, FAA, FAP and FAD anionic exchange resins, available from Fumatek, Bietigheim-Bissingen, Germany, polybenzimidazols, and ion exchange materials and membranes described in U.S. Pat. No. 7,348,088, incorporated herein by reference in its entirety.

Ion exchange resin include resin wherein a fraction of the repeat units are electrically neutral and a fraction of the repeat units have an ionic functional group. As defined herein, an ion exchange resin will be considered to be a resin having a mole fraction of repeat units having ionic functional groups of greater than about 0.15 and less than about 1.00. In some embodiments, the ion exchange resin has a mole fraction of repeat units having ionic functional groups of greater than about 0.15 and less than about 0.90, greater than about 0.15 and less than about 0.80, greater than about 0.15 and less than about 0.70, greater than about 0.30 and less than about 0.90, greater than about 0.30 and less than about 0.80, greater than about 0.30 and less than about 0.70 greater than about 0.45 and less than about 0.90, greater than about 0.45 and less than about 0.80, and even greater than about 0.45 and less than about 0.70. The ion exchange resin may be a cationic exchange resin or may be an anionic exchange resin. The ion exchange resin may, optionally, be a proton ion exchange resin. The type of ion exchange resin may be selected based on the type of ion that needs to be transported between the anolyte and catholyte through the ion permeable membrane. In some embodiments the ion exchange resin is insoluble in at least one of the anolyte and catholyte. The ionic functional group of the ion exchange resin may include, but is not limited, to carboxylate, sulphonate, sulfonamide, quaternary ammonium, thiuronium, guanidinium, imidazolium and pyridinium groups. Combinations of ionic functional groups may be used in an ion exchange resin. Mixtures of ion exchange resins resin may be used. Useful ion exchange resins include, but are not limited to, fluorinated ion exchange resins, e.g. perfluorosulfonic acid copolymer and perfluorosulfonimide copolymer, a sulfonated polysulfone, a polymer or copolymer containing quaternary ammonium groups, a polymer or copolymer containing at least one of guanidinium or thiuronium groups a polymer or copolymer containing imidazolium groups, a polymer or copolymer containing pyridinium groups. The resin may be a mixture of ionomer resin and ion exchange resin.

Non-ionic resins include, but are not limited to, homopolymers, copolymers and/or blends of epoxy resin, phenolic resin, polyurethanes, urea-formadehyde resin, melamine resin, polyesters, polyamides, polyethers, polycarbonates, polyimides, polysulphones, polyphenylene oxides, polyacrylates, polymethacylates, polyetherimides, polyketones, polyolefin, e.g. polyethylene and polypropylene, styrene and styrene based random and block copolymers, e.g. styrene-butadiene-styrene, polyvinyl chloride, and fluorinated polymers, including perfluorinated and partially fluorinated fluoropolymers that may be semi-crystalline and/or amorphous, e.g. polyvinylidene fluoride and polytetrafluoroethylene

The microporous protection layers of the present disclosure include at least one of an electrically conductive particulate and a non-electrically conductive particulate. The term “particulate” is meant to include particles, flakes, fibers, dendrites and the like. Particulate particles generally include particulates that have aspect ratios of length to width and length to thickness both of which are between about 1 and about 5. Particle size may be from between about 0.001 microns to about 100 microns, from between about 0.001 microns to about 50 microns, from between about 0.001 to about 25 microns, from between about 0.001 microns to about 10 microns, from about 0.001 microns to about 1 microns, from between about 0.01 microns and about 100 microns, from between about 0.01 microns to about 50 microns, from between about 0.01 to about 25 microns, from between about 0.01 microns to about 10 microns, from about 0.01 microns to about 1 microns, from between about 0.05 microns to about 100 microns, from between about 0.05 microns to about 50 microns, from between about 0.05 to about 25 microns, from between about 0.05 microns to about 10 microns, from about 0.05 microns to about 1 microns, from between about 0.1 microns and about 100 microns, from between about 0.1 microns to about 50 microns, from between about 0.1 to about 25 microns, from between about 0.1 microns to about 10 microns, or even from between about 0.1 microns to about 1 microns. Particles may be spheroidal in shape. Particulate flakes generally include particulates that have a length and a width each of which is significantly greater than the thickness of the flake. A flake includes particulates that have aspect ratios of length to thickness and width to thickness each of which is greater than about 5. There is no particular upper limit on the length to thickness and width to thickness aspect ratios of a flake. Both the length to thickness and width to thickness aspect ratios of the flake may be between about 6 and about 1000, between about 6 and about 500, between about 6 and about 100, between about 6 and about 50, between about 6 and about 25, between about 10 and about 500, between 10 and about 150, between 10 and about 100, or even between about 10 and about 50. The length and width of the flake may each be from between about 0.001 microns to about 50 microns, from between about 0.001 to about 25 microns, from between about 0.001 microns to about 10 microns, from about 0.001 microns to about 1 microns, from between about 0.01 microns to about 50 microns, from between about 0.01 to about 25 microns, from between about 0.01 microns to about 10 microns, from about 0.01 microns to about 1 microns, from between about 0.05 microns to about 50 microns, from between about 0.05 to about 25 microns, from between about 0.05 microns to about 10 microns, from about 0.05 microns to about 1 microns, from between about 0.1 microns to about 50 microns, from between about 0.1 to about 25 microns, from between about 0.1 microns to about 10 microns, or even from between about 0.1 microns to about 1 microns. Flakes may be platelet in shape. Particulate fibers generally include particulates that have aspect ratios of the length to width and length to thickness both of which are greater about 10 and a width to thickness aspect ratio less than about 5. For a fiber having a cross sectional area that is in the shape of a circle, the width and thickness would be the same and would be equal to the diameter of the circular cross-section. There is no particular upper limit on the length to width and length to thickness aspect ratios of a fiber. Both the length to thickness and length to width aspect ratios of the fiber may be between about 10 and about 1000000, between 10 and about 100000, between 10 and about 1000, between 10 and about 500, between 10 and about 250, between 10 and about 100, between about 10 and about 50, between about 20 and about 1000000, between 20 and about 100000, between 20 and about 1000, between 20 and about 500, between 20 and about 250, between 20 and about 100 or even between about 20 and about 50. The width and thickness of the fiber may each be from between about 0.001 to about 100 microns, from between about 0.001 microns to about 50 microns, from between about 0.001 to about 25 microns, from between about 0.001 microns to about 10 microns, from about 0.001 microns to about 1 microns, from between about 0.01 to about 100 microns, from between about 0.01 microns to about 50 microns, from between about 0.01 to about 25 microns, from between about 0.01 microns to about 10 microns, from about 0.01 microns to about 1 microns, from between about 0.05 to about 100 microns, from between about 0.05 microns to about 50 microns, from between about 0.05 to about 25 microns, from between about 0.05 microns to about 10 microns, from about 0.05 microns to about 1 microns, from between about 0.1 to about 100 microns, from between about 0.1 microns to about 50 microns, from between about 0.1 to about 25 microns, from between about 0.1 microns to about 10 microns, or even from between about 0.1 microns to about 1 microns. In some embodiments the thickness and width of the fiber may be the same. Particulate dendrites include particulates having a branched structure. The particle size of the dendrites may be the same as those disclosed for the particulate particles, discussed above.

In some embodiments, the electrically conductive particulate is at least one of a particle, a flake and a dendrite. In some embodiments, the non-electrically conductive particulate is at least one of a particle, a flake and a dendrite. In some embodiments, the electrically conductive particulate and the non-electrically conductive particulate are each at least one of a particle, a flake and a dendrite. In some embodiments, the particulate of a first microporous protection layer and the particulate of a second microporous protection layer are the same particulate. In some embodiments, the particulate of a first microporous protection layer and the particulate of a second microporous protection layer are different particulates.

Electrically conductive particulates may include metals, metalized dielectrics, e.g. metalized polymer particulates or metalize glass particulates, conductive polymers and carbon, including but not limited to, glass like carbon, amorphous carbon, graphene, graphite, carbon nanotubes and carbon dendrites, branched carbon nanotubes, e.g. carbon nanotrees. Electrically conductive particulates may include semi-conductor materials, e.g. BN, AlN and SiC. In some embodiments, the microporous protection layer is free of metal particulate.

In some embodiments, the electrically conductive particulate may be surface treated to enhance the wettability of the microporous protection layer to a given anolyte or catholyte or to provide or enhance the electrochemical activity of the microporous protection layer relative to the oxidation—reduction reactions associated with the chemical composition of a given anolyte or catholyte. Surface treatments include, but are not limited to, at least one of chemical treatments, thermal treatments and plasma treatments. In some embodiments, the electrically conductive particulate is hydrophilic.

In some embodiments, the amount of electrically conductive particulate contained in the resin of the microporous protection layer, on a weight basis, may be from about 5 to about 95 percent, from about 5 to about 90 percent, from about 5 to about 80 percent, from about 5 to about 70 percent, from about 10 to about 95 percent, from about 10 to about 90 percent, from about 10 to about 80 percent, from about 10 to about 70 percent, 25 to about 95 percent, from about 25 to about 90 percent, from about 25 to about 80 percent, from about 25 to about 70 percent, from about 30 to about 95 percent, from about 30 to about 90 percent, from about 30 to about 80 percent, from about 30 to about 70 percent, 40 to about 95 percent, from about 40 to about 90 percent, from about 40 to about 80 percent, from about 40 to about 70 percent, 50 to about 95 percent, from about 50 to about 90 percent, from about 10 to about 80 percent, or even from about 50 to about 70 percent.

Non-electrically conductive particulate include, but is not limited to non-electrically conductive inorganic particulate and non-electrically conductive polymeric particulate. In some embodiments, the non-electrically conductive particulate comprises a non-electrically conductive inorganic particulate. Non-electrically conductive inorganic particulate include, but is not limited to, minerals and clays known in the art. In some embodiments the non-electrically conductive inorganic particulate include at least one of silica, alumina, titania, and zirconia. In some embodiments, the non-electrically conductive particulate may be ionically conductive, e.g. a polymeric ionomer. In some embodiments, the non-electrically conductive particulate comprises a non-electrically conductive polymeric particulate. In some embodiments, the non-electrically conductive polymeric particulate is a non-ionic polymer, i.e. a polymer free of repeat units having ionic functional groups. Non-electrically conductive polymers include, but are not limited to, epoxy resin, phenolic resin, polyurethanes, urea-formadehyde resin, melamine resin, polyesters, polyamides, polyethers, polycarbonates, polyimides, polysulphones, polyphenylene oxides, polyacrylates, polymethacylates, polyolefin, e.g. polyethylene and polypropylene, styrene and styrene based random and block copolymers, e.g. styrene-butadiene-styrene, polyvinyl chloride, and fluorinated polymers, e.g. polyvinylidene fluoride and polytetrafluoroethylene. In some embodiments, the non-electrically conducive particulate is substantially free of a non-electrically conductive polymeric particulate. By substantially free it is meant that the non-electrically conductive particulate contains, by weight, between about 0% and about 5%, between about 0% and about 3%, between about 0% and about 2%, between about 0% and about 1%, or even between about 0% and about 0.5% of a non-electrically conductive polymeric particulate.

In some embodiments, the amount of non-electrically conductive particulate contained in the resin of the microporous protection layer, on a weight basis, may be from about 1 to about 99 percent, from about 1 to about 95 percent, from about 1 to about 90 percent, from about 1 to about 80 percent, from about 1 to about 70 percent, from about 5 to about 99 percent, from about 5 to about 95 percent, from about 5 to about 90 percent, from about 5 to about 80 percent, from about 5 to about 70 percent, from about 10 to about 99 percent, from about 10 to about 95 percent, from about 10 to about 90 percent, from about 10 to about 80 percent, from about 10 to about 70 percent, from about 25 to about 99 percent, from about 25 to about 95 percent, from about 25 to about 90 percent, from about 25 to about 80 percent, from about 25 to about 70 percent, from about 30 to 99 percent, from about 30 to about 95 percent, from about 30 to about 90 percent, from about 30 to about 80 percent, from about 30 to about 70 percent, from about 40 to about 99 percent, from about 40 to about 95 percent, from about 40 to about 90 percent, from about 40 to about 80 percent, from about 40 to about 70 percent, from about 50 to 99 percent, from about 50 to about 95 percent, from about 50 to about 90 percent, from about 10 to about 80 percent, or even from about 50 to about 70 percent.

In some embodiments, the amount of electrically conductive particulate and non-electrically conductive particulate, i.e. the total amount of particulate, contained in the resin of the microporous protection layer, on a weight basis, may be from about 1 to about 99 percent, from about 1 to about 95 percent, from about 1 to about 90 percent, from about 1 to about 80 percent, from about 1 to about 70 percent, from about 5 to about 99 percent, from about 5 to about 95 percent, from about 5 to about 90 percent, from about 5 to about 80 percent, from about 5 to about 70 percent, from about 10 to about 99 percent, from about 10 to about 95 percent, from about 10 to about 90 percent, from about 10 to about 80 percent, from about 10 to about 70 percent, from about 25 to about 99 percent, 25 to about 95 percent, from about 25 to about 90 percent, from about 25 to about 80 percent, from about 25 to about 70 percent, from about 30 to about 99 percent, from about 30 to about 95 percent, from about 30 to about 90 percent, from about 30 to about 80 percent, from about 30 to about 70 percent, from about 40 to about 99 percent, from about 40 to about 95 percent, from about 40 to about 90 percent, from about 40 to about 80 percent, from about 40 to about 70 percent, from about 50 to about 99 percent, from about 50 to about 95 percent, from about 50 to about 90 percent, from about 50 to about 80 percent, or even from about 50 to about 70 percent.

In some embodiments, the ratio of the weight of the resin of the microporous protection layer to total weight of particulate (sum of the electrically conductive particulate and non-electrically conductive particulate) is from about 1/99 to about 10/1, from about 1/20 to about 10/1, from about 1/10 to about 10/1, from about 1/5 to about 10/1, from about 1/4 to about 10/1, from about 1/3 to about 10/1, from about 1/2 to about 10/1, from about 1/99 to about 9/1, from about 1/20 to about 9/1, from about 1/10 to about 9/1, from about 1/5 to about 9/1, from about 1/4 to about 9/1, from about 1/3 to about 9/1, from about 1/2 to about 9/1, from about 1/99 to about 8/1, from about 1/20 to about 8/1, from about 1/10 to about 8/1, from about 1/5 to about 8/1, from about 1/4 to about 8/1, from about 1/3 to about 8/1, from about 1/2 to about 8/1, from about 1/99 to about 7/1, from about 1/20 to about 7/1, from about 1/10 to about 7/1, from about 1/5 to about 7/1, from about 1/4 to about 7/1, from about 1/3 to about 7/1, from about 1/2 to about 7/1, from about 1/99 to about 6/1, from about 1/20 to about 6/1, from about 1/10 to about 6/1, from about 1/5 to about 6/1, from about 1/4 to about 6/1, from about 1/3 to about 6/1, or even from about 1/2 to about 6/1.

The microporous protection layer may include both an electrically conductive particulate and a non-electrically conductive particulate. In some embodiments, the ratio of the weight of the electrically conductive particulate to the weight of the non-electrically conductive particulate is from about 0.1/100 to about 10/1, from about 1/100 to about 10/1, from about 4/100 to about 4/1, from about 1/10 to about 10/1, from about 1/4 to about 10/1, from about 1/3 to about 10/1, from about 1/2 to about 10/1, from about 1/1 to about 10/1, from about 0.1/100 to about 4/1, from about 1/100 to about 4/1, from about 4/100 to about 4/1, from about 1/10 to about 4/1, from about 1/4 to about 4/1, from about 1/3 to about 4/1, from about 1/2 to about 4/1, from about 1/1 to about 4/1, from about 0.1/100 to about 3/1, from about 1/100 to about 3/1, from about 4/100 to about 3/1, from about 1/10 to about 3/1, from about 1/4 to about 3/1, from about 1/3 to about 3/1, from about 1/2 to about 3/1, from about 1/1 to about 3/1, from about 0.1/100 to about 2/1, from about 1/100 to about 2/1, from about 4/100 to about 2/1, from about 1/10 to about 2/1, from about 1/4 to about 2/1, from about 1/3 to about 2/1, from about 1/2 to about 2/1, from about 0.1/100 to about 1/1, from about 1/100 to about 1/1, from about 4/100 to about 1/1, from about 1/10 to about 1/1, from about 1/4 to about 1/1, from about 1/3 to about 1/1, or even from about 1/2 to about 1/1. In some embodiments, that include both a first and a second microporous protection layers, at least one of the microporous protection layers may include both an electrically conductive particulate and a non-electrically conductive particulate. In some embodiments the first microporous protection layer includes both an electrically conductive particulate and a non-electrically conductive particulate. In some embodiments the second microporous protection layer includes both an electrically conductive particulate and a non-electrically conductive particulate. In some embodiments, both the first and second microporous layers may include both an electrically conductive particulate and a non-electrically conductive particulate.

The thickness of the microporous protection layer may be from about 0.5 micron to about 250 microns, from about 0.5 micron to about 100 microns, from about 0.5 micron to about 75 microns, from about 0.5 micron to about 50 microns, from about 1 micron to about 250 microns, from about 1 micron to about 100 microns, from about 1 micron to about 75 microns, from about 1 micron to about 50 microns, from about 5 microns to about 250 microns, from about 5 microns to about 100 microns, from about 5 microns to about 75 microns, or even from about 5 microns to about 50 microns. The porosity of the microporous protection layer, on a volume basis, may be from about 10 percent to 90 percent, from about 10 percent to about 80 percent, from about 10 percent to about 70 percent, from about 10 percent to about 70 percent, 20 percent to 90 percent, from about 20 percent to about 80 percent, from about 20 percent to about 70 percent, from about 20 percent to about 70 percent, 30 percent to 90 percent, from about 30 percent to about 80 percent, from about 30 percent to about 70 percent, or even from about 30 percent to about 70 percent.

In some embodiments, the microporous protection layer may be hydrophilic. This may be particularly beneficial when the microporous protection layers are to be used in conjunction with aqueous anolyte and/or catholyte solutions. In some embodiments the microporous protection layer may have a surface contact angle with water, catholyte and/or anolyte of less than 90 degrees. In some embodiments, the microporous protection layer may have a surface contact angle with water, catholyte and/or anolyte of between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees. Uptake of a liquid, e.g. water, catholyte and/or anolyte, into the pores of a microporous protection layer may be considered a key property for optimal operation of a liquid flow battery. In some embodiments, 100 percent of the pores of the microporous protection layer may be filled by the liquid. In other embodiments, between about 30 percent and about 100 percent, between about 50 percent and about 100 percent, between about 70 percent and about 100 percent or even between about 80 percent and 100 percent of the pores of the microporous protection layer may be filled by the liquid.

The microporous protection layers can be fabricated by combining the resin and at least one of an electrically conductive particulate and a non-electrically conductive particulate by solution blending, followed by solution coating. Solution blending includes adding the resin and at least one of an electrically conductive particulate and a non-electrically conductive particulate to an appropriate solvent followed by mixing at the desired shear rate, resulting in a microporous protection layer coating solution. Mixing may include using any techniques known in the art, including blade mixers and conventional milling, e.g. ball milling. The mixing techniques should provide the desired shear to provide the desired level of dispersion of the particulate in the coating solution. Other additives, including but not limited to, surfactants, dispersants, thickeners, wetting agents and the like, may be added to the solution. Surfactants, dispersants and thickeners may help to stabilize the at least one of the electrically conductive particulate and the non-electrically conductive particulate in the solution. They may also serve as viscosity modifiers. Prior to adding to the solution, the resin may be in the form of a dispersion, as would be generated if the resin was prepared via an emulsion polymerization technique, for example.

Solvent useful in the microporous protection layer coating solution may be selected based on the resin type and/or particulate type. Solvents useful in the microporous protection layer coating solution include, but are not limited to, water, alcohols (e.g. methanol, ethanol and propanol), acetone, ethyl acetate, alkyl solvents (e.g. pentane, hexane, cyclohexane, heptane and octane), methyl ethyl ketone, ethyl ethyl ketone, dimethyl ether, petroleum ether, toluene, benzene, xylenes, dimethylformamide, dimethylsulfoxide, chloroform, carbon tetrachloride, chlorobenzene and mixtures thereof.

Surfactants may be used in the microporous protection layer coating solutions, for example, to improve wetting and/or aid in dispersing of the electrically conductive particulate and the non-electrically conductive particulate. Surfactants may include cationic, anionic and nonionic surfactants. Surfactants useful in the microporous protection layer coating solution include, but are not limited to TRITON X-100, available from Dow Chemical Company, Midland, Mich.; DISPERSBYK 190, available from BYK Chemie GMBH, Wesel, Germany; amines, e.g. olyelamine and dodecylamine; amines with more than 8 carbons in the backbone,e.g. 3-(N, N-dimethyldodecylammonio) propanesulfonate (SB12); SMA 1000, available from Cray Valley USA, LLC, Exton, Pa.; 1,2-propanediol, triethanolamine, dimethylaminoethanol; quaternary amine and surfactants disclosed in U.S. Pat. Publ. No. 20130011764, which is incorporated herein by reference in its entirety. If one or more surfactants are used in the microporous protection layer coating solution, the surfactant may be removed from the microporous protection layer by a thermal process, wherein the surfactant either volatilizes at the temperature of the thermal treatment or decomposes and the resulting compounds volatilize at the temperature of the thermal treatment. In some embodiments, the microporous protection layer is substantially free of surfactant. By “substantially free” it is meant that the microporous protection layer contains, by weight, from 0 percent to 0.5 percent, from 0 percent to 0.1 percent, from 0 percent to 0.05 percent or even from 0 percent to 0.01 percent surfactant. In some embodiments, the microporous protection layer contains no surfactant. The surfactant may be removed from the microporous protection layer by washing or rinsing with a solvent of the surfactant. Solvents include, but are not limited to water, alcohols (e.g. methanol, ethanol and propanol), acetone, ethyl acetate, alkyl solvents (e.g. pentane, hexane, cyclohexane, heptane and octane), methyl ethyl ketone, ethyl ethyl ketone, dimethyl ether, petroleum ether, toluene, benzene, xylenes, dimethylformamide, dimethylsulfoxide, chloroform, carbon tetrachloride, chlorobenzene and mixtures thereof.

The microporous protection layer may be formed from the microporous protection layer coating solution by coating the solution on a release liner, for example, optional release liner 30 and/or 32 of FIGS. 1A and 1B, and then drying the microporous protection layer coating solution coating to remove the solvent. The resulting microporous protection layer can then be laminated to a surface of the ion exchange membrane using conventional lamination techniques, which may include at least one of pressure and heat, thereby forming a membrane assembly a shown in FIG. 1A (without optional release liner 32). A second microporous protection layer may be laminated to the opposite surface of the ion exchange membrane, thereby forming a membrane assembly, as shown in FIG. 1B. The microporous protection layer coating solution may be coated directly on at least one of the first surface and the second surface of the ion exchange membrane. The coating solution coating is then dried to form a microporous protection layer and the corresponding membrane assemblies. The membrane assemblies may have either one microporous protection layer, if the coating is applied to only one surface of the ion exchange membrane (FIG. 1A without optional release liners), or two microporous protection layers, if the coating is applied to both surfaces of the ion exchange membrane (FIG. 1B without optional release liners).

In an alternative approach, the microporous protection layer coating solution may be coated on a release liner, for example, optional release liner 30 and/or 32 of FIGS. 1A and 1B. A first surface of an ion exchange membrane may then be disposed on the microporous protection layer coating solution coating. The microporous protection layer coating solution coating may then be dried, forming a microporous protection layer and the corresponding membrane assembly, FIG. 1A, without optional release liner 32. A second microporous protection layer may then be formed on the second surface of the ion exchange membrane by using any of the previously disclosed coating techniques, forming a membrane assembly having two microporous protection layers, FIG. 1B.

Any suitable method of coating may be used to coat the microporous protection layer coating solution on either a release liner or the ion exchange membrane. Typical methods include both hand and machine methods, including hand brushing, notch bar coating, fluid bearing die coating, wire-wound rod coating, fluid bearing coating, slot-fed knife coating, and three-roll coating. Most typically three-roll coating is used. Advantageously, coating is accomplished without bleed-through of the microporous protection layer coating solution from the coated side of the ion exchange membrane to the uncoated side. Coating may be achieved in one pass or in multiple passes. Coating in multiple passes may be useful to increase coating weight without corresponding increases in cracking of the microporous protection layer.

The amount of solvent, on a weight basis, in the microporous protection layer coating solution may be from about 5 to about 95 percent, from about 10 to about 95 percent, from about 20 to about 95 percent, from about 30 to about 95 percent, from about 40 to about 95 percent, from about 50 to about 95 percent, from about 60 to about 95 percent, from about 5 to about 90 percent, from about 10 to about 90 percent, from about 20 percent to about 90 percent, from about 30 to about 90 percent, from about 40 to about 90 percent, from about 50 to about 90 percent, from about 60 to about 90 percent, from about 5 to about 80 percent, from about 10 to about 80 percent from about 20 percent to about 80 percent, from about 30 to about 80 percent, from about 40 to about 80 percent, from about 50 to about 80 percent, from about 60 to about 80 percent, from about 5 percent to about 70 percent, from about 10 percent to about 70 percent, from about 20 percent to about 70 percent, from about 30 to about 70 percent, from about 40 to about 70 percent, or even from about 50 to about 70 percent.

The amounts, on a weight basis, of the resin and the at least one of an electrically conductive particulate and the non-electrically conductive particulate in the microporous protection layer coating solution may be calculated based on the previous disclosure of the weight of at least one of the electrically conductive particulate and the non-electrically conductive particulate contained in the resin of the microporous protection layer and the weight of solvent in the microporous protection layer coating solution.

If the microporous protection layer coating solution is to be coated onto a release liner and then dried, the viscosity of the coating solution is not particularly limited. The viscosity of the coating solution can be adjusted by known techniques, including, but not limited to adjusting the percent solids of the solution, adding appropriate thickeners, adding appropriate dispersants and/or surfactants.

The microporous protection layer may include a single film layer or it may include two or more film layers, formed, for example, by coating a first microporous protection layer coating solution on a substrate (e.g. an electrode, an ion exchange membrane or a release liner), followed by drying, to form a first microporous protection film layer and then coating a second microporous protection layer coating solution on top of the first coating, followed by drying, to form a second microporous protection film layer. The two film layers form the microporous protection layer. The number of film layers forming the microporous protection layer is not particularly limited. In some embodiments, the microporous protection layer comprises at least one film layer. In some embodiments, the microporous protection layer comprises two or more film layers. The film layers of the microporous protection layer may be the same composition or may include two or more different compositions.

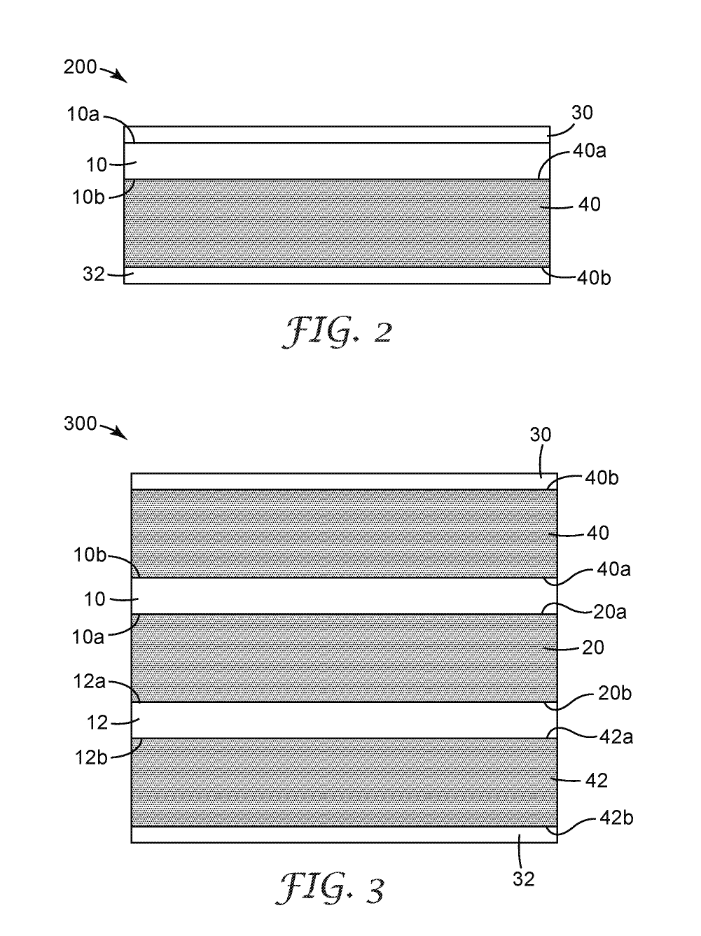

The membrane assemblies and membrane-electrode assemblies of the present disclosure include an ion change membrane (element 20, of FIGS. 1A, 1B and 3). Ion exchange membranes known in the art may be used. Ion exchange membranes are often referred to as separators and may be prepared from ion exchange resins, for example, those previously discussed for the microporous protection layer. In some embodiments, the ion exchange membranes may include a fluorinated ion exchange resin. Ion exchange membranes useful in the embodiments of the present disclosure may be fabricated from ion exchange resins known in the art or be commercially available as membrane films and include, but are not limited to, NAFION PFSA MEMBRANES, available from DuPont, Wilmington, Del.; AQUIVION PFSA, a perfluorosulfonic acid, available from SOLVAY, Brussels, Belgium; FLEMION and SELEMION, fluoropolomer ion exchange membranes, available from Asahi Glass, Tokyo, Japan; FUMASEP ion exchange membranes, including FKS, FKB, FKL, FKE cation exchange membranes and FAB, FAA, FAP and FAD anionic exchange membranes, available from Fumatek, Bietigheim-Bissingen, Germany and ion exchange membranes and materials described in U.S. Pat. No. 7,348,088, incorporated herein by reference in its entirety. The ion exchange resins useful in the fabrication of the ion exchange membrane may be the ion exchange resin previously disclosed herein with respect to the microporous protection layer.

The ion exchange membranes of the present disclosure may be obtained as free standing films from commercial suppliers or may be fabricated by coating a solution of the appropriate ion exchange membrane resin in an appropriate solvent, and then heating to remove the solvent. The ion exchange membrane may be formed from an ion exchange membrane coating solution by coating the solution on a release liner and then drying the ion exchange membrane coating solution coating to remove the solvent. The first surface of the resulting ion exchange membrane can then be laminated to a first surface of a microporous protection layer using conventional lamination techniques, which may include at least one of pressure and heat, forming a membrane assembly a shown in FIG. 1A (without optional release liner 30). A first surface of a second microporous protection layer may then be laminated to the second surface of the ion exchange membrane, forming a membrane assembly, as shown in FIG. 1B. The optional release liners may remain with the assembly until it is used to fabricate a membrane-electrode assembly, in order to protect the outer surface of the microporous protection layer from dust and debris. The release liners may also provide mechanical support and prevent tearing of the microporous protection layer and/or marring of its surface, prior to fabrication of the membrane-electrode assembly. The ion exchange membrane coating solution may be coated directly on a surface of a microporous protection layer. The ion exchange membrane coating solution coating is then dried to form an ion exchange membrane and the corresponding membrane assembly, FIG. 1A. If a second microporous protection layer is laminated or coated on the exposed surface of the formed ion exchange membrane, a membrane assembly with two microporous protection layer may be formed, see FIG. 1B. The ion exchange membrane coating solution may be coated between two microporous protection layers and then dried to form a membrane assembly.

Any suitable method of coating may be used to coat the ion exchange membrane coating solution on either a release liner or the a microporous protection layer. Typical methods include both hand and machine methods, including hand brushing, notch bar coating, fluid bearing die coating, wire-wound rod coating, fluid bearing coating, slot-fed knife coating, and three-roll coating. Most typically three-roll coating is used. Advantageously, coating is accomplished without bleed-through of the ion exchange membrane coating from the coated side of the microporous protection layer to the uncoated side. Coating may be achieved in one pass or in multiple passes. Coating in multiple passes may be useful to increase coating weight without corresponding increases in cracking of the ion exchange membrane.

The amount of solvent, on a weight basis, in the ion exchange membrane coating solution may be from about 5 to about 95 percent, from about 10 to about 95 percent, from about 20 to about 95 percent, from about 30 to about 95 percent, from about 40 to about 95 percent, from about 50 to about 95 percent, from about 60 to about 95 percent, from about 5 to about 90 percent, from about 10 to about 90 percent, from about 20 percent to about 90 percent, from about 30 to about 90 percent, from about 40 to about 90 percent, from about 50 to about 90 percent, from about 60 to about 90 percent, from about 5 to about 80 percent, from about 10 to about 80 percent from about 20 percent to about 80 percent, from about 30 to about 80 percent, from about 40 to about 80 percent, from about 50 to about 80 percent, from about 60 to about 80 percent, from about 5 percent to about 70 percent, from about 10 percent to about 70 percent, from about 20 percent to about 70 percent, from about 30 to about 70 percent, from about 40 to about 70 percent, or even from about 50 to about 70 percent.

The amount of ion exchange resin, on a weight basis, in the ion exchange membrane coating solution may be from about 5 to about 95 percent, from about 5 to about 90 percent, from about 5 to about 80 percent, from about 5 to about 70 percent, from about 5 to about 60 percent, from about 5 to about 50 percent, from about 5 to about 40 percent, from about 10 to about 95 percent, from about 10 to about 90 percent, from about 10 to about 80 percent, from about 10 to about 70 percent, from about 10 to about 60 percent, from about 10 to about 50 percent, from about 10 to about 40 percent, from about 20 to about 95 percent, from about 20 to about 90 percent, from about 20 to about 80 percent, from about 20 to about 70 percent, from about 20 to about 60 percent, from about 20 to about 50 percent, from about 20 to about 40 percent, from about 30 to about 95 percent, from about 30 to about 90 percent, from about 30 to about 80 percent, from about 30 to about 70 percent, from about 30 to about 60 percent, or even from about 30 to about 50 percent.

The electrode assemblies and membrane-electrode assemblies of the present disclosure include at least one porous electrode. The porous electrode of the present disclosure is electrically conductive and the porosity facilitates the oxidation/reduction reaction that occur therein by increasing the amount of active surface area for reaction to occur, per unit volume of electrode, and by allowing the anolyte and catholyte to permeate into the porous regions and access this additional surface area. The porous electrodes may include at least one of woven and nonwoven fiber mats, woven and nonwoven fiber papers, felts, cloths, as well as, open cell foams. The porous electrode may include carbon materials, including but not limited to, glass like carbon, amorphous carbon, graphene, carbon nanotubes and graphite. Particularly useful porous electrode materials include carbon papers, carbon felts and carbon cloths. In one embodiment, the porous electrode includes at least one of carbon paper, carbon felt and carbon cloth.

The thickness of the porous electrode may be from about 10 microns to about 1000 microns, from about 10 microns to about 500 microns, from about 10 microns to about 250 microns, from about 10 microns to about 100 microns, from about 25 microns to about 1000 microns, from about 25 microns to about 500 microns, from about 25 microns to about 250 microns, or even from about 25 microns to about 100 microns. The porosity of the porous electrodes, on a volume basis, may be from about 5 percent to about 95 percent, from about 5 percent to about 90 percent, from about 5 percent to about 80 percent, from about 5 percent to about 70 percent, from about 10 percent to about 95 percent, from about 10 percent to 90 percent, from about 10 percent to about 80 percent, from about 10 percent to about 70 percent, from about 10 percent to about 70 percent, from about 20 percent to about 95 percent, from about 20 percent to about 90 percent, from about 20 percent to about 80 percent, from about 20 percent to about 70 percent, from about 20 percent to about 70 percent, from about 30 percent to about 95 percent, from about 30 percent to about 90 percent, from about 30 percent to about 80 percent, or even from about 30 percent to about 70 percent.

The porous electrode may be a single layer or multiple layers of woven and nonwoven fiber mats; woven and nonwoven fiber papers, felts, and cloths; and foams; multi-layer papers and felts having particular utility. When the porous electrode includes multiple layers, there is no particular limit as to the number of layers that may be used. However, as there is a general desire to keep the thickness of electrode assembly and membrane assembly as thin as possible, the porous electrode may include from about 2 to about 20 layers, from about 2 to about 10 layers, from about 2 to about 8 layer, from about 2 to about 5 layers, from about 3 to about 20 layers, from about 3 to about 10 layers, from about 3 to about 8 layers, or even from about 3 to about 5 layers of woven and nonwoven fiber mats and woven and nonwoven fiber papers, felts, cloths, and foams. In some embodiments the porous electrode includes from about 2 to about 20 layers, from about 2 to about 10 layers, from about 2 to about 8 layer, from about 2 to about 5 layers, from about 3 to about 20 layers, from about 3 to about 10 layers, from about 3 to about 8 layers, or even from about 3 to about 5 layers of carbon paper, carbon felt and/or carbon cloth.

In some embodiments, the porous electrode may be surface treated to enhance the wettability of the porous electrode to a given anolyte or catholyte or to provide or enhance the electrochemical activity of the porous electrode relative to the oxidation—reduction reactions associated with the chemical composition of a given anolyte or catholyte. Surface treatments include, but are not limited to, at least one of chemical treatments, thermal treatments and plasma treatments. Thermal treatments of porous electrodes may include heating to elevated temperatures in an oxidizing atmosphere, e.g. oxygen and air. Thermal treatments may be at temperatures from about 100 to about 1000 degrees centigrade, from about 100 to about 850 degrees centigrade, from about 100 to about 700 degrees centigrade, 200 to about 1000 degrees centigrade, from about 200 to about 850 degrees centigrade, from about 200 to about 700 degrees centigrade, from about 300 to about 1000 degrees centigrade, from about 300 to about 850 degrees centigrade, or even from about 300 to about 700 degrees centigrade. The duration of the thermal treatment may be from about 0.1 hours to about 60 hours, from about 0.25 hour to about 60 hours, from about 0.5 hour to about 60 hours, from about 1 hour to about 60 hours, from about 3 hours to about 60 hours, from about 0.1 hours to about 48 hours, from about 0.25 hour to about 48 hours, from about 0.5 hour to about 48 hours, from about 1 hour to about 48 hours, from about 3 hours to about 48 hours, from about 0.1 hours to about 24 hours, from about 0.25 hour to about 24 hours, from about 0.5 hour to about 24 hours, from about 1 hour to about 24 hours from about 3 hours to about 24 hours, from about 0.1 hours to about 12 hours, from about 0.25 hour to about 12 hours, from about 0.5 hour to about 12 hours, from about 1 hour to about 12 hours, or even from about 3 hours to about 48 hours. In some embodiments, the porous electrode includes at least one of a carbon paper, carbon felt and carbon cloth that has been thermally treated in at least one of an air, oxygen, hydrogen, nitrogen, argon and ammonia atmosphere at a temperature from about 300 degrees centigrade to about 700 degrees centigrade for between about 0.0.1 hours and 12 hours.

In some embodiments, the porous electrode may be hydrophilic. This may be particularly beneficial when the porous electrode is to be used in conjunction with aqueous anolyte and/or catholyte solutions. Uptake of a liquid, e.g. water, catholyte and/or anolyte, into the pores of a liquid flow battery electrode may be considered a key property for optimal operation of a liquid flow battery. In some embodiments, 100 percent of the pores of the electrode may be filled by the liquid, creating the maximum interface between the liquid and the electrode surface. In other embodiments, between about 30 percent and about 100 percent, between about 50 percent and about 100 percent, between about 70 percent and about 100 percent or even between about 80 percent and 100 percent of the pores of the electrode may be filled by the liquid. In some embodiments, the porous electrode may have a surface contact angle with water, catholyte and/or anolyte of less than 90 degrees. In some embodiments, the porous electrode may have a surface contact angle with water, catholyte and/or anolyte of between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees.

Electrode assemblies may be fabricated similarly to the fabrication of the membrane assemblies, except the ion exchange membrane is replace by the porous electrode. An electrode assembly may be formed by laminating a porous electrode to the second surface of a previously formed microporous protection layer (FIG. 2, without optional release liners 30 and 32). The electrode assembly may also be formed by coating a microporous protection layer coating solution onto a release liner, drying the microporous protection layer coating solution coating to form a microporous protection layer and then laminating a porous electrode onto the second surface (exposed surface) of the microporous protection layer, forming an electrode assembly (FIG. 2, without optional release liner 32). The electrode assembly may also be formed by coating a microporous protection layer coating solution onto a release liner, disposing a porous electrode onto the exposed surface of the microporous protection layer coating solution coating and then drying the microporous protection layer coating solution coating to form a microporous protection layer and the corresponding electrode assembly (FIG. 2, without optional release liner 32). The electrode assembly may also be formed by coating a microporous protection layer coating solution directly onto the first surface of the porous electrode and then drying the microporous protection layer coating solution coating to form a microporous protection layer and the corresponding electrode assembly (FIG. 2, without optional release liner 30 and 32)

In some embodiments, the present disclosure also provides membrane-electrode assemblies. The microporous protection layers, ion exchange membranes, porous electrodes and their corresponding membrane assemblies and electrode assemblies of the present disclosure may be used to fabricate membrane-electrode assemblies. FIG. 3 shows a schematic cross-sectional side view of a membrane-electrode assembly 300. Membrane-electrode assembly 300 includes an ion exchange membrane 20 having a first surface 20a and an opposed second surface 20b; a first and second microporous protection layer, 10 and 12, respectively, each having a first surface, 10a and 12a, respectively, and an opposed second surface, 10b and 12b, respectively. The first surface 20a of ion exchange membrane 20 is in contact with first surface 10a of first microporous protection layer 10 and second surface 20b of ion exchange membrane 20 is in contact with first surface 12a of the second microporous protection layer. Membrane-electrode assembly 300 further includes a first and second porous electrode, 40 and 42 respectively, each having a first surface, 40a and 42a, respectively, and an opposed second surface, 40b and 42b, respectively; wherein the first surface 40a of first porous electrode 40 is proximate to the second surface 10b of first microporous protection layer 10 and first surface 42a of the second porous electrode 42 is proximate to second surface 12b of second microporous protection layer 12. In some embodiments, first surface 40a of first porous electrode 40 is in contact with second surface 10b of the first microporous protection layer 10. In some embodiments, first surface 42a of second porous electrode 42 is in contact with second surface 12b of second microporous protection layer 12. In another embodiment, first surface 40a of first porous electrode 40 is in contact with second surface 10b of first microporous protection layer 10 and first surface 42a of second porous electrode 42 is in contact with second surface 12b of second microporous protection layer 12. Membrane-electrode assembly 300 may further include one or more optional release liners 30, 32.

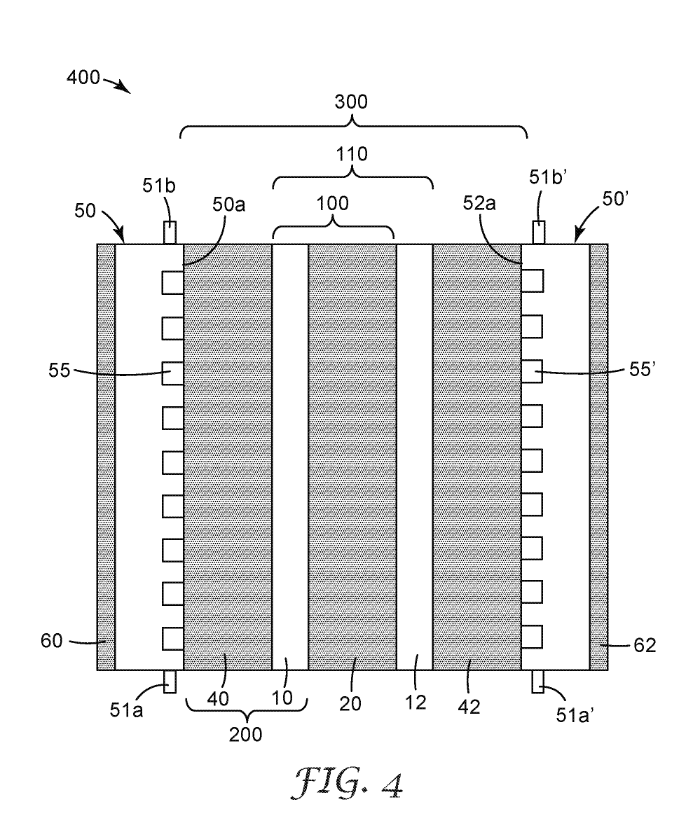

The microporous protection layers, ion exchange membranes, porous electrodes and their corresponding membrane assemblies, electrode assemblies and membrane-electrode assemblies of the present disclosure may be used to fabricate an electrochemical cell for use in, for example, a liquid flow battery, e.g. a redox flow battery. In some embodiments, the present disclosure provides an electrochemical cell that include one or more of a membrane assembly, an electrode assembly and a membrane-electrode assembly. In one embodiment, the present disclosure provides an electrochemical cell including a membrane assembly according to any one of the previous membrane-assembly embodiments. In another embodiment, the present disclosure provides an electrochemical cell including an electrode assembly according to any one of the previous electrode assembly embodiments. In yet another embodiment, the present disclosure provides an electrochemical cell including a membrane-electrode assembly according to any one of the previous membrane-electrode assembly embodiments. FIG. 4 shows a schematic cross-sectional side view of electrochemical cell 400, which includes membrane-electrode assembly 300, end plates 50 and 50′ having fluid inlet ports, 51a and 51a′, respectively, and fluid outlet ports, 51b and 51b′, respectively, flow channels 55 and 55′, respectively and first surface 50a and 52a respectively. Electrochemical cell 400 also includes current collectors 60 and 62. Membrane-electrode assembly 300 is as described in FIG. 3. Electrochemical cell 400 includes porous electrodes 40 and 42, microporous protection layers 10 and 12 and ion exchange membrane 20, all as previously described. End plates 50 and 51 are in electrical communication with porous electrodes 40 and 42, respectively, through surfaces 50a and 52a, respectively. Support plates, not shown, may be placed adjacent to the exterior surfaces of current collectors 60 and 62. The support plates are electrically isolated from the current collector and provide mechanical strength and support to facilitate compression of the cell assembly. In some embodiments, electrochemical cell 400 includes a membrane assembly 100, including an ion exchange membrane 20 having a first surface 20a and an opposed second surface 20b, a first microporous protection layer 10 having a first surface 10a and an opposed second surface 10b. First surface 20a of ion exchange membrane 20 is in contact with first surface 10a of first microporous protection layer 10 (see FIG. 1A). In some embodiments, electrochemical cell 400 includes a membrane assembly 110, including an ion exchange membrane 20 having a first surface 20a and an opposed second surface 20b, a first microporous protection layer 10 having a first surface 10a and an opposed second surface 10b and a second microporous protection layer 12 having a first surface 12a and an opposed second surface 12b. First surface 20a of ion exchange membrane 20 is in contact with first surface 10a of first microporous protection layer 10. Second surface 20b of ion exchange membrane 20 is in contact with first surface 12a of second microporous protection layer 12 (see FIG. 1B). In some embodiments, electrochemical cell 400 includes an electrode assembly 200 including a porous electrode 40 having a first surface 40a and an opposed second surface 40b, and a first microporous protection layer 10 having a first surface 10a and an opposed second surface 10b. In some embodiments, the first surface 40a of porous electrode 40 is proximate the second surface 10b of the first microporous protection layer 10. In some embodiments, the first surface 40a of porous electrode 40 is in contact with the second surface 10b of the first microporous protection layer 10 (see FIG. 2). End plates 50 and 50′ include fluid inlet and outlet ports and flow channels that allow anolyte and catholyte solutions to be circulated through the electrochemical cell. Assuming the anolyte is flowing through plate 50 and the catholyte is flowing through plate 50′, the flow channels 55 allow the anolyte to contact and flow into porous electrode 40, facilitating the oxidation-reduction reactions of the cell. Similarly, for the catholyte, the flow channels 55′ allow the catholyte to contact and flow into porous electrode 42, facilitating the oxidation-reduction reactions of the cell. The current collectors may be electrically connected to an external circuit.

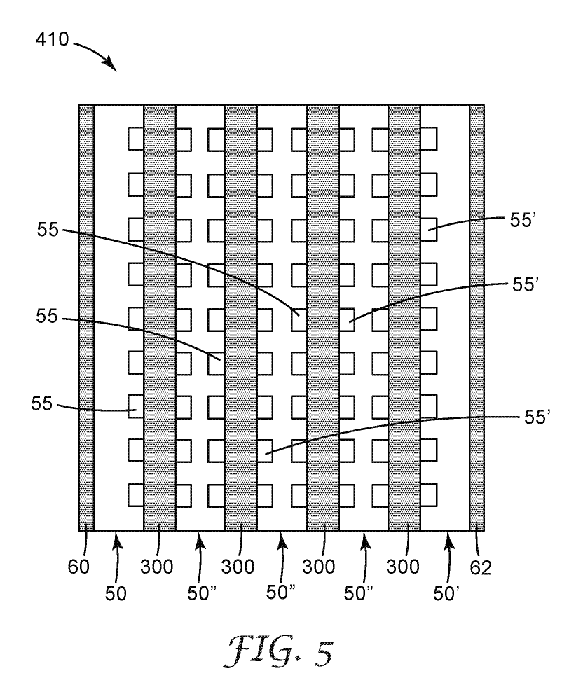

The electrochemical cells of the present disclosure may include multiple electrode-membrane assemblies fabricated from at least one of the membrane assemblies, electrode assemblies, microporous protection layers, porous electrodes and ion exchange membranes disclosed herein. In one embodiment of the present disclosure, an electrochemical cell is provided including at least two membrane-electrode assemblies, according to any one of the membrane-electrode assemblies described herein. FIG. 5 shows a schematic cross-sectional side view of electrochemical cell stack 410 including membrane-electrode assemblies 300, separated by bipolar plates 50″ and end plates 50 and 50′ having flow channels 55 and 55′. Bipolar plates 50″ allow anolyte to flow through one set of channels, 55 and catholyte to flow through a seconds set of channels, 55′, for example. Cell stack 410 includes multiple electrochemical cells, each cell represented by a membrane-electrode assembly and the corresponding adjacent bipolar plates and/or end plates. Support plates, not shown, may be placed adjacent to the exterior surfaces of current collectors 60 and 62. The support plates are electrically isolated from the current collector and provide mechanical strength and support to facilitate compression of the cell assembly. The anolyte and catholyte inlet and outlet ports and corresponding fluid distribution system is not show. These features may be provided as known in the art.

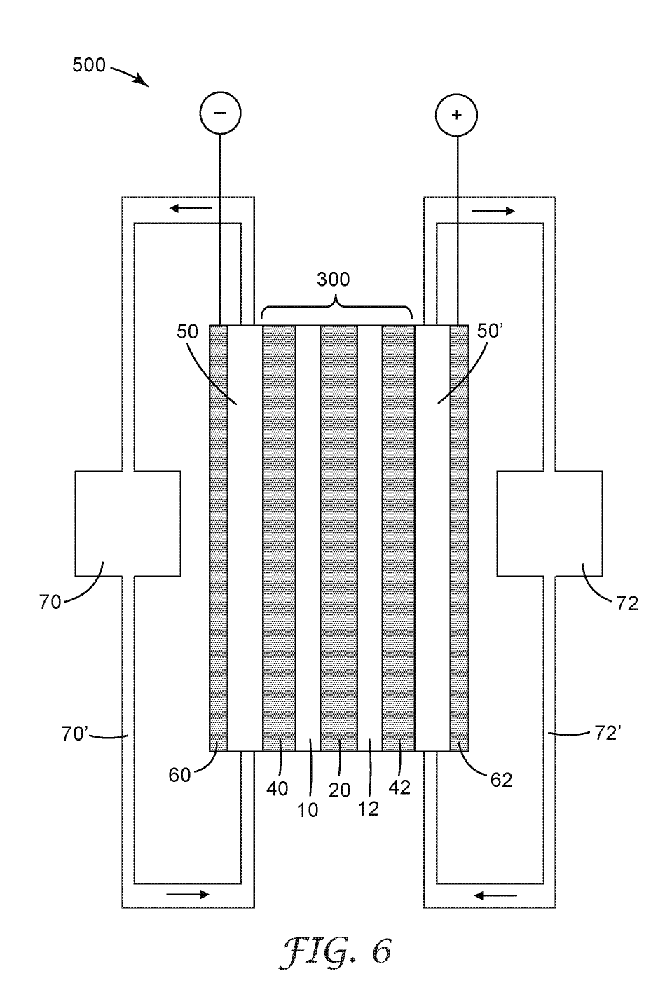

The microporous protection layers, ion exchange membranes, porous electrodes and their corresponding membrane assemblies, electrode assemblies and membrane-electrode assemblies of the present disclosure may be used to fabricate a liquid flow battery, e.g. a redox flow battery. In some embodiments, the present disclosure provides a liquid flow battery that include one or more of a membrane assembly, an electrode assembly and a membrane-electrode assembly. In one embodiment, the present disclosure provides a liquid flow battery including a membrane assembly according to any one of the previous membrane assembly embodiments. In another embodiment, the present disclosure provides a liquid flow battery including an electrode assembly according to any one of the previous electrode assembly embodiments. In yet another embodiment, the present disclosure provides a liquid flow battery including a membrane-electrode assembly according to any one of the previous membrane-electrode assembly embodiments. FIG. 6 shows a schematic view of an exemplary single cell, liquid flow battery including membrane-electrode assembly 300, which includes microporous protection layers 10 and 12, ion exchange membrane 20 and porous electrodes 40 and 42, current collectors 60 and 62, anolyte reservoir 70 and anolyte fluid distribution 70′, and catholyte reservoir 72 and catholyte fluid distribution system 72′. Pumps for the fluid distribution system are not shown. Current collectors 60 and 62 may be connected to an external circuit which includes an electrical load (not shown). Although a single cell liquid flow battery is shown, it is known in the art that liquid flow batteries may contain multiple electrochemical cells, i.e. a cell stack. Further multiple cell stacks may be used to form a liquid flow battery, e. g. multiple cell stacks connected in series. The microporous protection layers, ion exchange membranes, porous electrodes and their corresponding membrane assemblies, electrode assemblies and membrane-electrode assemblies of the present disclosure may be used to fabricate liquid flow batteries having multiple cells, for example, multiple cell stack of FIG. 5. Flow fields may be present, but this is not a requirement.

The membrane assemblies, electrode assemblies and membrane-electrode assemblies of the present disclosure may provide improved cell short resistance and cell resistance. Cell short resistance is a measure of the resistance an electrochemical cell has to shorting, for example, due to puncture of the membrane by conductive fibers of the electrode. In some embodiments, a test cell, as described in the Example section of the present disclosure, which includes at least one of a membrane assembly, electrode assembly and membrane-electrode assembly of the present disclosure may have a cell short resistance of greater than 1000 ohm-cm², greater than 5000 ohm-cm² or even greater than 10000 ohm-cm². In some embodiments the cell short resistance may be less than about 10000000 ohm-cm². Cell resistance is a measure of the electrical resistance of an electrochemical cell through the membrane assembly, i.e. laterally across the cell, shown in FIG. 4. In some embodiments, a test cell, as described in the Example section of the present disclosure, which includes at least one of a membrane assembly, electrode assembly and membrane-electrode assembly of the present disclosure may have a cell resistance of between about, 0.01 and about 10 ohm-cm², 0.01 and about 5 ohm-cm², between about 0.01 and about 1 ohm-cm², between about 0.04 and about 0.5 ohm-cm² or even between about 0.07 and about 0.1 ohm-cm².

In some embodiments of the present disclosure the liquid flow battery may be a redox flow battery, for example, a vanadium redox flow battery (VRFB), wherein a V³⁺/V²⁺ sulfate solution serves as the negative electrolyte (“anolyte”) and a V⁵⁺/V⁴⁺ sulfate solution serves as the positive electrolyte (“catholyte”). It is to be understood, however, that other redox chemistries are contemplated and within the scope of the present disclosure, including, but not limited to, V²⁺/V³⁺ vs. Br⁻/ClBr₂, Br₂/Br⁻ vs. S/S²⁻, Br⁻/Br₂ vs. Zn²⁺/Zn, Ce⁴⁺/Ce³⁺ vs. V²⁺/V³⁺, Fe³⁺/Fe²⁺ vs. Br₂/Br⁻, Mn²⁺/Mn³⁺ vs. Br₂/Br⁻, Fe³⁺/Fe²⁺ vs. Ti²⁺/Ti⁴⁺ and Cr³⁺/Cr²⁺, acidic/basic chemistries. Other chemistries useful in liquid flow batteries include coordination chemistries, for example, those disclosed in U.S. Pat. Appl. Nos. 2014/028260, 2014/0099569, and 2014/0193687 and organic complexes, for example, U.S. Pat. Publ. No. 2014/370403 and international application published under the patent cooperation treaty Int. Publ. No. WO 2014/052682, all of which are incorporated herein by reference in their entirety.

In one embodiment, a first method of making a membrane assembly includes providing a first microporous protection layer coating solution, coating the first microporous protection layer coating solution on a first surface of a provided ion exchange membrane, drying the microporous protection layer coating solution coating to form a first microporous protection layer, thereby forming a membrane assembly. In another embodiment, the first method may further include providing a second microporous protection layer coating solution, coating the second microporous protection layer coating solution on a second surface of the provided ion exchange membrane, drying the second microporous protection layer coating solution coating to form a second microporous protection layer, thereby forming a membrane assembly. In another embodiment, the first method may include providing a second microporous protection layer coating solution, coating the second microporous protection layer coating solution on a provided first release liner, drying the second microporous protection layer coating solution coating to form a second microporous protection layer with a first surface, laminating the first surface of the second microporous protection layer to a second surface of the provided ion exchange membrane. The methods may further include removing the first release liner. The first and second microporous protection layer coating solutions may be the same or different.

In one embodiment, a second method of making a membrane assembly includes providing a first microporous protection layer coating solution, coating the first microporous protection layer coating solution on a provided first release liner, drying the microporous protection layer coating solution coating to form a microporous protection layer with a first surface, laminating the first surface of the microporous protection layer to a first surface of a provided ion exchange membrane, thereby forming a membrane assembly. In another embodiment, the second method may further includes providing a second microporous protection layer coating solution, coating second the microporous protection layer coating solution on a provided second release liner, drying the second microporous protection layer coating solution coating to form a second microporous protection layer with a first surface, laminating the first surface of the second microporous protection layer to a second surface of the provided ion exchange membrane, thereby forming a membrane assembly. In another embodiment, the second method may further include providing a second microporous protection layer coating solution, coating the second microporous protection layer coating solution on a second surface of the provided ion exchange membrane, drying the second microporous protection layer coating solution coating to form a second microporous protection layer, thereby forming a membrane assembly. The first and second microporous protection layer coating solutions may be the same or different. The methods may further include removing one or both of the first and second release liners. The first and second microporous protection layer coating solutions may be the same or different.

In one embodiment, a third method of making a membrane assembly includes providing a first microporous protection layer coating solution, coating the first microporous protection layer coating solution on a provided first release liner, applying a first surface of a provided ion exchange membrane to the surface of the coated first microporous protection layer coating solution, drying the first microporous protection layer coating solution coating to form a first microporous protection layer, thereby forming a membrane assembly. The third method may further include removing the first release liner prior to drying the first microporous protection layer coating solution coating. The third method may further include removing the first release liner after drying the first microporous protection layer coating solution coating. In another embodiment, the third method may further include providing a second microporous protection layer coating solution, coating the second microporous protection layer coating solution on a provided second release liner, applying a second surface of the provided ion exchange membrane to the surface of the coated second microporous protection layer coating solution, drying the second microporous protection layer coating solution coating to form a second microporous protection layer, thereby forming a membrane assembly. The third method may further include removing the second release liner prior to drying the second microporous protection layer coating solution coating. The third method may further include removing the second release liner after drying the second microporous protection layer coating solution coating. In another embodiment, the third method may further include providing a second microporous protection layer coating solution, coating the second microporous protection layer coating solution on a second surface of the provided ion exchange membrane, drying the second microporous protection layer coating solution coating to form a second microporous protection layer, thereby forming a membrane assembly. In another embodiment, the method may include providing a second microporous protection layer coating solution, coating the second microporous protection layer coating solution on a provided second release liner, drying the second microporous protection layer coating solution coating to form a second microporous protection layer with a first surface, laminating the first surface of the second microporous protection layer to a second surface of the provided ion exchange membrane. The method may further include removing the second release liner. The first and second microporous protection layer coating solutions may be the same or different.

In one embodiment, a first method of making an electrode assembly includes providing a first microporous protection layer coating solution, coating the first microporous protection layer coating solution on a first surface of a provided porous electrode, drying the microporous protection layer coating solution coating to form a first microporous protection layer, thereby forming an electrode assembly.

In one embodiment, a second method of making an electrode assembly includes providing a first microporous protection layer coating solution, coating the first microporous protection layer coating solution on a provided first release liner, drying the microporous protection layer coating solution coating to form a microporous protection layer with a first surface, laminating the first surface of the microporous protection layer to a first surface of a provided porous electrode, thereby forming an electrode assembly. The method may further include removing the first release liner.

In one embodiment, a third method of making an electrode assembly includes providing a first microporous protection layer coating solution, coating the first microporous protection layer coating solution on a provided first release liner, applying a first surface of a provided porous electrode to the surface of the coated first microporous protection layer coating solution, drying the first microporous protection layer coating solution coating to form a first microporous protection layer, thereby forming an electrode assembly. The third method may further include removing the first release liner prior to drying the first microporous protection layer coating solution coating. The third method may further include removing the first release liner after drying the first microporous protection layer coating solution coating.

Methods of making membrane-electrode assemblies include laminating the exposed surface of a microporous protection layer of a membrane assembly, e.g. second surface 10b and/or second surface 12b of FIGS. 1A and 1B, each to a surface of a porous electrode, i.e. surface 40a and/or 42a of FIG. 3. This may be conducted by hand or under heat and/or pressure using conventional lamination equipment. Additionally, the membrane-electrode assembly may be formed during the fabrication of an electrochemical cell or battery. The components of the cell may be layered on top of one another in the desired order, for example, a first porous electrode, a membrane assembly, e.g. membrane assembly 110 without optional release liners, and a second porous electrode. The components are then assembled between, for example, the end plates of a single cell or bipolar plates of a stack having multiple cells, along with any other required gasket/sealing material. The plates, with membrane assembly there between, are then coupled together, usually by a mechanical means, e.g. bolts, clamps or the like, the plates providing a means for holding the membrane assembly together and in position within the cell.

Methods of making membrane-electrode assemblies include laminating the exposed surface of one or more microporous protection layer of an electrode assembly, e.g. first surface 10a of FIG. 2, each to a surface of a ion exchange membrane, i.e. surface 20a and/or 20b (if two electrode assemblies are going to be laminated to a single ion exchange membrane) of FIG. 3. This may be conducted by hand or under heat and/or pressure using conventional lamination equipment. Additionally, the membrane-electrode assembly may be formed during the fabrication of an electrochemical cell or battery. The components of the cell may be layered on top of one another in the desired order, for example, a first electrode assembly, e.g. that shown in FIG. 2 without optional release liners, an ion exchange membrane, and a second electrode assembly. Each of the first exposed surfaces of the microporous protection layers of the electrode assemblies are in contact with one of the first and second surface of the ion exchange membrane, as depicted in FIG. 3. The components are then assembled between, for example, the end plates of a single cell or bipolar plates of a stack having multiple cells, along with any other required gasket/sealing material. The plates, with membrane assembly there between, are then coupled together, usually by a mechanical means, e.g. bolts, clamps or the like, the plates providing a means for holding the membrane assembly together and in position within the cell.

Select embodiments of the present disclosure include, but are not limited to, the following:

In a first embodiment, the present disclosure provides a membrane assembly for a liquid flow battery comprising:
an ion exchange membrane having a first surface and an opposed second surface;
a first microporous protection layer having a first surface and an opposed second surface; wherein the first surface of the ion exchange membrane is in contact with the first surface of the first microporous protection layer; and the first microporous protection layer comprises:
   a resin; and
   at least one of an electrically conductive particulate and a non-electrically conductive particulate, wherein the ratio of the weight of the resin to total weight of particulate is from about 1/99 to about 10/1.

In a second embodiment, the present disclosure provides a membrane assembly for a liquid flow battery according to the first embodiment further comprising a second microporous protection layer have a first surface and an opposed second surface; wherein the second surface of the ion exchange membrane is in contact with the first surface of the second microporous protection layer; and the second microporous protection layer comprises:
a resin; and
at least one of an electrically conductive particulate and a non-electrically conductive particulate, wherein the ratio of the weight of the resin to total weight of particulate is from about 1/99 to about 10/1.

In a third embodiment, the present disclosure provides a membrane assembly for a liquid flow battery according to the first or second embodiments, wherein the ratio of the weight of the resin to total weight of particulate is from about 1/3 to about 10/1 in the first microporous protection layer, and, optionally, in the second microporous protection layer.

In a fourth embodiment, the present disclosure provides a membrane assembly for a liquid flow battery according to any one of the first through third embodiments, wherein the electrically conductive particulate and the non-electrically conductive particulate are each at least one of a particle, a flake and a dendrite.

In a fifth embodiment, the present disclosure provides a membrane assembly for a liquid flow battery according to any one of the first through fourth embodiments, wherein the electrically conductive particulate is at least one of carbon particles, carbon flakes and carbon dendrites.

In a sixth embodiment, the present disclosure provides a membrane assembly according to any one of the first through fifth embodiments, wherein at least one of the first microporous protection layer and the second microporous protection layer include both an electrically conductive particulate and a non-electrically conductive particulate.

In a seventh embodiment, the present disclosure provides a membrane assembly for a liquid flow battery according to any one of the second through sixth embodiments, wherein both the first and second microporous layers include both an electrically conductive particulate and a non-electrically conductive particulate.

In an eighth embodiment, the present disclosure provides a membrane assembly for a liquid flow battery according to the sixth or seventh embodiments, wherein the ratio of the weight of the electrically conductive particulate to the weight of the non-electrically conductive particulate is from about 1/4 to about 4/1.

In a ninth embodiment, the present disclosure provides a membrane assembly for a liquid flow battery according to any one of the first through eighth embodiments, wherein the non-electrically conductive particulate comprises a non-electrically conductive inorganic particulate.

In a tenth embodiment, the present disclosure provides a membrane assembly for a liquid flow battery according to the ninth embodiment, wherein the non-electrically conductive inorganic particulate is at least one of silica, alumina, ceria, titania, and zirconia.

In an eleventh embodiment, the present disclosure provides membrane assembly for a liquid flow battery for a liquid flow battery according to any one of the first through tenth embodiments, wherein the resin includes an ionic resin and, optionally, wherein the ionic resin includes at least one of a perfluorosulfonic acid copolymer, a perfluorosulfonimide copolymer, a sulfonated polysulfone, a polymer or copolymer containing quaternary ammonium groups, a polymer or copolymer containing at least one of guanidinium or thiuronium groups a polymer or copolymer containing imidazolium groups, a polymer or copolymer containing pyridinium groups.

In an twelfth embodiment, the present disclosure provides a membrane assembly for a liquid flow battery according to the eleventh embodiment, wherein the ionic resin is a cationic exchange resin and, optionally, wherein the cationic exchange resin is a proton ion exchange resin.

In a thirteenth embodiment, the present disclosure provides a membrane assembly for a liquid flow battery according to the eleventh embodiment, wherein the ionic resin is an anionic exchange resin.

In a fourteenth embodiment, the present disclosure provides a membrane assembly for a liquid flow battery according to any one of the first through tenth embodiments wherein the resin comprises a non-ionic resin, and optionally, wherein the non-ionic resin includes at least one of polyethylene, high density polyethylene, ultra-high molecular weight polyethylene, polypropylene, chlorinated polyvinyl chloride, perfluorinated fluoropolymer and partially fluorinated fluoropolymer, perfluorinated fluoropolymer and partially fluorinated fluoropolymer, polyetherimide and polyketone, epoxy resin, phenolic resin, polyurethane, urea-formadehyde resin and melamine resin.

In a fifteenth embodiment, the present disclosure provides an electrode assembly for a liquid flow battery comprising:
a porous electrode having a first surface and an opposed second surface;
a first microporous protection layer having a first surface and an opposed second surface; wherein the first surface of the porous electrode is proximate the second surface of the first microporous protection layer; and the first microporous protection layer comprises:
   a resin; and

at least one of an electrically conductive particulate and a non-electrically conductive particulate, wherein the ratio of the weight of the resin to total weight of particulate is from about 1/99 to about 10/1.

In a sixteenth embodiment, the present disclosure provides an electrode assembly for a liquid flow battery according to the fifteenth, wherein the ratio of the weight of the resin to total weight of particulate is from about 1/3 to about 10/1.

In a seventeenth embodiment, the present disclosure provides an electrode assembly for a liquid flow battery according to the fifteenth or sixteenth embodiments, wherein the electrically conductive particulate and the non-electrically conductive particulate are each at least one of a particle, a flake and a dendrite.

In an eighteenth embodiment, the present disclosure provides an electrode assembly for a liquid flow battery according to any one of the fifteenth through seventeenth embodiments, wherein the electrically conductive particulate is at least one of carbon particles, carbon flakes and carbon dendrites.

In a nineteenth embodiment, the present disclosure provides an electrode assembly for a liquid flow battery according to any one of the fifteenth through eighteenth embodiments, wherein the first microporous protection layer includes both an electrically conductive particulate and a non-electrically conductive particulate.

In a twentieth embodiment, the present disclosure provides an electrode assembly for a liquid flow battery according to the nineteenth embodiment, wherein the ratio of the weight of the electrically conductive particulate to the weight of the non-electrically conductive particulate is from about 1/4 to about 4/1.

In a twenty-first embodiment, the present disclosure provides an electrode assembly for a liquid flow battery according to any one of the fifteenth through twentieth embodiments, wherein the non-electrically conductive particulate comprises a non-electrically conductive inorganic particulate.

In a twenty-second embodiment, the present disclosure provides an electrode assembly for a liquid flow battery according to the twenty-first embodiment, wherein the non-electrically conductive inorganic particulate is at least one of silica, alumina, titania and zirconia.

In a twenty-third embodiment, the present disclosure provides an electrode assembly for a liquid flow battery for a liquid flow battery according to any one of the fifteenth through twenty-second embodiments, wherein the resin includes an ionic resin and, optionally, wherein the ionic resin includes at least one of a perfluorosulfonic acid copolymer, a perfluorosulfonimide copolymer, a sulfonated polysulfone, a polymer or copolymer containing quaternary ammonium groups, a polymer or copolymer containing at least one of guanidinium or thiuronium groups a polymer or copolymer containing imidazolium groups, a polymer or copolymer containing pyridinium groups.

In a twenty-fourth embodiment, the present disclosure provides an electrode assembly for a liquid flow battery according to the twenty-third embodiment, wherein the ionic resin is a cationic exchange resin and, optionally, wherein the cationic exchange resin is a proton ion exchange resin.

In a twenty-fifth embodiment, the present disclosure provides an electrode assembly for a liquid flow battery according to the twenty-third embodiment, wherein the ionic resin is an anionic exchange resin.

In a twenty-sixth embodiment, the present disclosure provides an electrode assembly for a liquid flow battery according to any one of the fifteenth through twenty-second embodiments, wherein the resin comprises a non-ionic resin, and optionally, wherein the non-ionic resin includes at least one of polyethylene, high density polyethylene, ultra-high molecular weight polyethylene, polypropylene, chlorinated polyvinyl chloride, perfluorinated fluoropolymer and partially fluorinated fluoropolymer, perfluorinated fluoropolymer and partially fluorinated fluoropolymer, polyetherimide and polyketone, epoxy resin, phenolic resin, polyurethane, urea-formadehyde resin and melamine resin.

In a twenty-seventh embodiment, the present disclosure provides an electrode assembly for a liquid flow battery according to any one of the fifteenth through twenty-sixth embodiments, wherein the porous electrode comprises at least one of carbon paper, carbon felt, and carbon cloth.

In a twenty-eighth embodiment, the present disclosure provides an electrode assembly for a liquid flow battery according to any one of the fifteenth through twenty-seventh embodiments, wherein the porous electrode is hydrophilic.

In a twenty-ninth embodiment, the present disclosure provides a membrane-electrode assembly for a liquid flow battery comprising: an ion exchange membrane having a first surface and an opposed second surface;
a first and second microporous protection layer each having a first surface and an opposed second surface; wherein the first surface of the ion exchange membrane is in contact with the first surface of the first microporous protection layer and the second surface of the ion exchange membrane is in contact with the first surface of the second microporous protection layer; and the first and second first microporous protection layers comprise:
   a resin; and
   at least one of an electrically conductive particulate and a non-electrically conductive particulate, wherein the ratio of the weight of the resin to total weight of particulate is from about 1/99 to about 10/1; and

a first and second porous electrode each having a first surface and an opposed second surface; wherein the first surface of the first porous electrode is proximate to the second surface of the first microporous protection layer and the first surface of the second porous electrode is proximate to the second surface of the second microporous protection layer.

In a thirtieth embodiment, the present disclosure provides a membrane-electrode assembly for a liquid flow battery according to the twenty-ninth embodiment, wherein the ratio of the weight of the resin to total weight of particulate is from about 1/3 to about 10/1 in the first microporous protection layer, and, optionally, in the second microporous protection layer.

In a thirty-first embodiment, the present disclosure provides a membrane-electrode assembly for a liquid flow battery according to the twenty-ninth or thirtieth embodiments, wherein the electrically conductive particulate and the non-electrically conductive particulate are each at least one of a particle, a flake and a dendrite.

In a thirty-second embodiment, the present disclosure provides a membrane-electrode assembly for a liquid flow battery according to any one of the twenty-ninth through thirty-first embodiments, wherein the electrically conductive particulate is at least one of carbon particles, carbon flakes and carbon dendrites.

In a thirty-third embodiment, the present disclosure provides a membrane-electrode assembly for a liquid flow battery according to any one of the twenty-ninth through thirty-second embodiments, wherein at least one of the first microporous protection layer and the second microporous protection layer include both an electrically conductive particulate and a non-electrically conductive particulate.

In a thirty-fourth embodiment, the present disclosure provides a membrane-electrode assembly for a liquid flow battery according to any one of the twenty-ninth through thirty-third embodiments, wherein both the first and second microporous layers include both an electrically conductive particulate and a non-electrically conductive particulate.

In a thirty-fifth embodiment, the present disclosure provides a membrane-electrode assembly for a liquid flow battery according to the thirty-third or thirty-fourth embodiments, wherein the ratio of the weight of the electrically conductive particulate to the weight of the non-electrically conductive particulate is from about 1/4 to about 4/1.

In a thirty-sixth embodiment, the present disclosure provides a membrane-electrode assembly for a liquid flow battery according to any one of the twenty-ninth through thirty-fifth embodiments, wherein the non-electrically conductive particulate comprises a non-electrically conductive inorganic particulate.

In a thirty-seventh embodiment, the present disclosure provides a membrane-electrode assembly for a liquid flow battery according to the thirty-sixth embodiments, wherein the non-electrically conductive inorganic particulate is at least one of silica, alumina, titania and zirconia.

In a thirty-eighth embodiment, the present disclosure provides a membrane-electrode assembly for a liquid flow battery according to any one of the twenty-ninth through thirty-seventh embodiments, wherein the resin includes an ionic resin and, optionally, wherein the ionic resin includes at least one of a perfluorosulfonic acid copolymer, a perfluorosulfonimide copolymer, a sulfonated polysulfone, a polymer or copolymer containing quaternary ammonium groups, a polymer or copolymer containing at least one of guanidinium or thiuronium groups a polymer or copolymer containing imidazolium groups, a polymer or copolymer containing pyridinium groups.

In a thirty-ninth embodiment, the present disclosure provides a membrane-electrode assembly for a liquid flow battery according to any one of the twenty-ninth through thirty-seventh embodiments, wherein the ionic resin is a cationic exchange resin and, optionally, wherein the cationic exchange resin is a proton ion exchange resin.

In a fortieth embodiment, the present disclosure provides a membrane-electrode assembly for a liquid flow battery according to any one of the twenty-ninth through thirty-seventh embodiments, wherein the ionic resin is an anionic exchange resin.

In a forty-first embodiment, the present disclosure provides a membrane-electrode assembly for a liquid flow battery according to any one of the twenty-ninth through fortieth embodiments, wherein the porous electrode comprises at least one of carbon paper, carbon felt and carbon cloth.

In a forty-second embodiment, the present disclosure provides an electrochemical cell for a liquid flow battery comprising a membrane assembly according to any one of the first through fourteenth embodiment.

In a forty-third embodiment, the present disclosure provides an electrochemical cell for a liquid flow battery comprising an electrode assembly according to any one of the fifteenth through twenty-eighth embodiments.

In a forty-forth embodiment, the present disclosure provides an electrochemical cell for a liquid flow battery comprising a membrane-electrode assembly according to any one of the twenty-ninth through forty-first embodiments.

In a forty-fifth embodiment, the present disclosure provides a liquid flow battery comprising a membrane assembly according to any one of the first through fourteenth embodiment.

In a forty-sixth embodiment, the present disclosure provides a liquid flow battery comprising an electrode assembly according to any one of the fifteenth through twenty-eighth embodiments.

In a forty-seventh embodiment, the present disclosure provides a liquid flow battery comprising a membrane-electrode assembly according to any one of the twenty-ninth through forty-first embodiments.

### Examples

Membrane and electrode assemblies with microporous protection layer coatings were prepared using coating and laminating methods. The resultant constructions provide membrane and electrode assemblies articles which provide improved cell short resistance and cell resistance as shown in the following examples.

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company, St. Louis, Mo. unless otherwise noted.

Materials

| Abbreviation or Trade Name | Description |
|---|---|
| 3M PFSA PEM | 25 micron thick membrane prepared from |
| | 3M825EW following the Membrane preparation |
| | procedure described in the EXAMPLE section of |
| | U.S. Pat. No. 7,348,088. |
| GDL H2315 | Carbon paper (gas diffusion layer), having a |
| | thickness of 210 microns at 0.025 MPa, an area |
| | weight of 95 g/m², an air permeability of 400 l/m³ |
| | s and a through plane electrical resistance of 4.5 mOhm/cm² |
| | at 1 MPa, available under the trade |
| | designation “Freudenberg GDL H2315” from |
| | Freudenberg Fuel Cell Component Technologies |
| | SE&CO.KG, Weinheim, Germany. |
| GDL 34AA | Carbon paper (gas diffusion layer), having a |
| | thickness of 280 microns, a basis weight of 82 g/m², |
| | an air permeability of 45 cm³/cm² s and an |
| | electrical resistivity of 6 mOhm/cm², available |
| | under the trade designation “SIGRACET GDL |
| | 34AA” from SGL Group, Wiesbadan, Germany, |
| | via distributor MFC Technology Ltd., |
| | Sagamihara, Kanagawa Prefecture, Japan. |
| 3M825EW | An aqueous solution of a perfluorosulfonic acid |
| | ionomer having an 825 equivalent weight, |
| | available under the trade designation |
| | “3M825EW”, from the 3M Company, St. Paul, |
| | Minnesota. |
| 3M1000EW | An aqueous solution of a perfluorosulfonic acid |
| | ionomer having a 1000 equivalent weight, |
| | available under the trade designation |
| | “3M1000EW”, from the 3M Company. |
| 825EW 3M Ionomer Powder | A spray dried powder of 3M825EW |
| 1000EW 3M Ionomer Powder | A spray dried powder of 3M1000EW |
| 825EW 3M Ionomer Dispersion | A 9.15 percent solids dispersion of 825EW 3M |
| | Ionomer Powder in deionized water |
| 1000EW 3M Ionomer Dispersion | A 19.3 percent solids dispersion of 1000EW 3M |
| | Ionomer Powder in a 70/30 wt./wt. mixture of n- |
| | propanol and deionized water. |
| A200 | Fumed silica under the trade designation “A200 |
| | Aerosil” from Nippon Aerosil Co., Ltd., Tokyo, |
| | Japan. |
| Denka Carbon Black | A carbon black, obtained from thermal |
| | decomposition of acetylene, available under the |
| | trade designation “Denka Black” from Denki |
| | Kagaku Kogyo K.K., Chuo-Ku, Japan |
| 400R | Carbon nanoparticles, available under the trade |
| | designation “CABOT 400R”, from Cabot |
| | Corporation, Boston, Massachusetts |

### Electrochemical Cell Preparation Procedure

The dried microporous protection layer coated electrodes and ion exchange membrane, 3M PFSA PEM were die cut by hand into 25 cm² pieces, using a conventional die, for cell short resistance testing. The flow plates of the test cell were commercially available quad serpentine flow channel with 25 cm² active area, available from Fuel Cell Technologies, Albuquerque, N. Mex. Examples being tested were assembled in the cell with a general configuration as that shown in FIG. 4, with the 25 cm² area of the Example aligning with the 25 cm² area of the flow plates. Note that each individual electrodes of the cell was composed of the microporous protection layer coated electrode and an adjacent layer of the corresponding electrode material that was not coated (producing a multi-layer electrode). The microporous protection layer was placed adjacent to the membrane during cell assembly. The cell assembly further included two picture frame gaskets, each adjacent to one of the plates. The size of the gasket opening was configure to allow the carbon paper (electrode) to align with the gasket frame, allowing the gasket to seal on the ion exchange membrane. After assembling in the cell, the bolts of the cell were tightened in a star shaped pattern to a 110 in lbf torque. Spacers were used to set a hard stop for the compression of each carbon paper (electrode). Spacers were either a silicone reinforced glass fiber mesh and/or a polyimide optical grade film and were combined to hit the target thickness corresponding to the hard stop for the desired cell compression. The compression is defined as (thickness of the carbon paper minus the thickness of spacers) divided by the thickness of the carbon paper times 100 and is expressed as a percentage.

For Example 3, the ion exchange membrane was replaced by the membrane assembly of Example 3 and the electrodes were cut from GDL 34AA. Note, each individual electrode of the cell was composed of two pieces of GDL 34AA stacked to form a single electrode.

For Comparative Example CE-A, the membrane was 3M PFSA PEM and the electrodes were cut from GDL 34AA. Note, each individual electrode of the cell was composed of two pieces of GDL 34AA stacked to form a single electrode.

For Comparative Example CE-B, the membrane was 3M PFSA PEM and the electrodes were cut from GDL H2315. Note, each individual electrode of the cell was composed of two pieces of GDL H2315 stacked to form a single electrode.

For Comparative Example CE-C, the membrane was 3M PFSA PEM and the electrodes were cut from the heat treated GDL 34AA. Note, each individual electrode of the cell was composed of two pieces of heat treated GDL 34AA stacked to form a single electrode. Details of the heat treatment are described below.

### Cell Short Resistance Test Method

Electronic short measurements were carried out using a digital multimeter MAS-344, available from Precision Mastech Enterprise Co., Ltd, Hong Kong. The short resistance measurement was conducted by connecting terminals of the tester to current collector plates of the cell assembly with cables. All measurements were done in ambient condition without any gas or liquid stream into the cell assembly.

### Cell Resistance Test Method

Cell resistance measurements were carried out using an AC impedance meter at 10 kHz, model 356E, available from TSURUGA ELECTRIC CORPORATION, 1-3-23, Minamisumiyoshi Sumiyoshi-ku, Osaka-shi, Osaka-fu, Japan. Two Teflon tubes were connected to the inlet ports of the cell assembly described in the Cell Short Resistance Test Method. Liquid water was fed into the cell at 20 ml/minute by using HPLC pumps, available from, Lab Alliance, State College, Pa. The cell resistance measurement was conducted by connecting terminals of the AC impedance meter to current collector plates of the cell assembly with cables.

### Microporous Protection Layer Coating Solution 1 (MPL-CS1)

MPL-CS1 was prepared as follows: 12 grams of A200 and 56.2 grams of 825EW 3M Ionomer Dispersion were dispensed into a glass jar and allowed to homogenize at 15000 RPM for 10 minutes using PRIMIX D142 laboratory homogenizer from PRIMIX corporation, Ebie, Fukushima-ku, Osaka, Japan. Then, 140 grams of zirconia beads (1.5 mm in diameter) were added into the said glass jar and was shaken for 15 hours by using a shaker, forming MPL-CS1.

### Microporous Protection Layer Coating Solution 2 (MPL-CS2)

MPL-CS2 was prepared as follows: 12 grams of Denka Carbon Black and 56.2 grams of 825EW 3M Ionomer Dispersion were dispensed into a glass jar and allowed to homogenize at 15000 RPM for 10 minutes using PRIMIX D142 laboratory homogenizer from PRIMIX corporation, Ebie, Fukushima-ku, Osaka, Japan. Then, 140 grams of zirconia beads (1.5 mm in diameter) were added into the said glass jar and was shaken for 15 hours by using a shaker, forming MPL-CS2.

### Microporous Protection Layer Coating Solution 3 (MPL-CS3)

MPL-CS3 was prepared as follows: 50 parts by weight of MPL-CS1 was mixed with 50 parts by weight of MPL-CS2, forming MPL-CS3.

### Microporous Protection Layer Coating Solution 4 (MPL-CS4)

MPL-CS4 was prepared as follows: 14 grams of A200, 31.1 grams of 1000EW 3M Ionomer Dispersion were dispensed into a glass jar and allowed to homogenize at 15000 RPM for 10 minutes using PRIMIX D142 laboratory homogenizer from PRIMIX corporation, Ebie, Fukushima-ku, Osaka, Japan. Then, 140 grams of zirconia beads (1.5 mm in diameter) were added into the said glass jar and was shaken for 12 hours by using a shaker, forming MPL-CS4.

### Microporous Protection Layer Coating Solution 5 (MPL-CS5)

MPL-CS5 was prepared as follows: 14 grams of Denka Carbon Black, 31.1 grams of 1000EW 3M Ionomer Dispersion were dispensed into a glass jar and allowed to homogenize at 15000 RPM for 10 minutes using PRIMIX D142 laboratory homogenizer from PRIMIX corporation, Ebie, Fukushima-ku, Osaka, Japan. Then, 140 grams of zirconia beads (1.5 mm in diameter) were added into the said glass jar and was shaken for 12 hours by using a shaker, forming MPL-CS5.

### Microporous Protection Layer Coating Solution 6 (MPL-CS6)

MPL-CS6 was prepared as follows: 50 parts by weight of MPL-CS4 was mixed with 50 parts by weight of MPL-CS5, forming MPL-CS6.

### Microporous Protection Layer Coating Solution 7 (MPL-CS7)

MPL-CS7 was prepared as follows: 173.55 g DI water was added to a 250 mL HDPE bottle. To this 28.04 g 825EW 3M Ionomer Powder was added. A Fisherbrand 1.5 inch (3.8 cm) polygon spinbar was added. The formulation was stirred on an RCT B 51 magnetic stir plate, available from IKA Works, Inc., Wilmington, N.C., for >24 hours to create an Ionomer dispersion. Next 65.4 g of 400R was added while stirring. The spin bar was removed and 5 mm High Density Zirconium Oxide beads (Glenn Mills Inc., Clifton, N.J. were added filling about 1/4 of the volume of the HDPE bottle. 18.82 g additional 400R were added and shaken by hand for 30 seconds. This yielded a final composition of 35 wt % solids in solution with a solids ratio of 30 wt % 825EW 3M Ionomer Powder and 70 wt. % 400R. The bottle was placed on a Boekel Grant ORS200 vial bath, available from Boekel Scientific, Feasterville, Pa. The vial bath did not contain water and the bottle was placed on its side. The ORS200 vial bath was turned on to 200 RPM's and milled for 40 hours, producing MPL-CS7.

### Example 1: (Electrode Assembly)

A first coating of MPL-CS4 was coated on GDL 34AA by using a No. 5 wire bar. The MPL-CS-4 coated GDL 34AA was dried at 100 degrees centigrade for 2 minutes and annealed at 150 degrees centigrade for 15 minutes, forming a first microporous protection layer coated on GDL 34AA. A second coating of MPL-CS-4 is coated on the first dried microporous protection layer using the No. 5 wire. The second coating was dried at 100 degrees centigrade for 2 minutes and annealed at 150 centigrade for 15 minutes, forming Example 1, electrode assembly. The two step coating process yielded a microporous protection layer coating thickness of 30 microns (total thickness of both dried coatings) on one surface of the GDL 34AA substrate.

### Example 2: (Electrode Assembly)

Example 2 was prepared similarly to Example 1, except MPL-CS4 was replaced by MPL-CS3. The two step coating process yielded a microporous protection layer coating thickness of 65 microns (total thickness of both dried coatings) on one surface of the GDL 34AA substrate.

### Example 3 (Membrane Assembly)

A first coating of MPL-CS6 was coated on a 60 micron thick polypropylene release liner by using a knife coater. The coated polypropylene substrate was dried at 100 degrees centigrade for 2 minutes, forming a microporous protection layer on the release liner. The thickness of the dried MPL-CS6 coating was 11 microns. Two pieces of the coated polypropylene release liner were used to simultaneously transfer the microporous protection layer to both sides of an ion exchange membrane, 3M PFSA PEM. The ion exchange membrane was sandwiched between two pieces of the MPL-CS6 dried coating with liner and was laminated together using a steel to steel heat-roll laminator, both rolls heated to 160 centigrade, with a roll gap of 320 microns and a line speed of 0.3 m/min. Note, the microporous protection layers were in contact with the ion exchange membrane during lamination. The laminate was annealed at 150 centigrade for 15 minutes, forming Example 3.

### Example 4: (Electrode Assembly)

Example 4 was prepared similarly to Example 1, except MPL-CS4 was replaced by MPL-CS2. The two step coating process yielded a microporous protection layer coating thickness of 4 microns (total thickness of both dried coatings) on one surface of the GDL 34AA substrate.

### Example 5: (Electrode Assembly)

MPL-CS7 was pipetted onto GDL H2315 in front of a 1 mil (25 micron) notch bar. The notch bar was pulled across GDL H2315 by hand to produce the coating. The coating on GDL H2315 was placed in a Blue M Electric 146 series A ventilated batch oven, available from Thermal Product Solutions, New Columbia, Pa. The coated paper was dried at 80 centigrade for 30 minutes and was then removed from the oven.

### Example 6: (Electrode Assembly)

Example 6 was prepared similarly to Example 5, except a 2 mil (51 micron) notch bar was used in place of the 1 mil (25 micron) notch bar.

### Example 7: (Electrode Assembly)

Example 7 was prepared similarly to Example 5, except a 3.5 mil (89 micron) notch bar was used in place of the 1 mil (25 micron) notch bar.

### Example 8: (Electrode Assembly)

Example 8 was prepared similarly to Example 1, except MPL-CS4 was replaced by MPL-CS2. The two step coating process yielded a microporous protection layer coating thickness of 35 microns (total thickness of both dried coatings) on one surface of the GDL 34AA substrate. Prior to coating, the GDL 34AA substrate was thermally treated at 600 centigrade for 30 minutes in a model F310 muffle furnace available from Yamato Scientific Co., Ltd. Chuo-ku, Tokyo, Japan.

### Comparative Example A (CE-A)

CE-A was GDL 34AA without a microporous protection layer.

### Comparative Example B (CE-B)

CE-B was GDL H2315 without a microporous protection layer.

### Comparative Example C (CE-C)

CE-C was GDL 34AA without a microporous protection layer, thermally treated at 600 centigrade for 30 minutes in a model F310 muffle furnace, available from Yamato Scientific Co., Ltd. Chuo-ku, Tokyo, Japan.

### Results:

The membrane and electrode assemblies of Examples 1-6 and Comparative Examples CE-A, CE-B and CE-B were used to fabricate liquid flow electrochemical cells, per the Electrochemical Cell Preparation Procedure, described above. Cell short resistance and cell resistance were measure per the Cell Short Resistance and Cell Resistance Test Methods, described previously. Results are shown in Table 1.

TABLE 1

| | | Ion Exchange | | |
|---|---|---|---|---|
| | | Membrane | Short | Cell |
| | Compression of | Thickness | Resistance | Resistance |
| Example | Cell Assembly | (micron) | (Ohm-cm²) | (Ohm-cm²) |
| 1 | 25% | 25 | >50000 | 3.80 |
| 2 | 45% | 25 | 11250 | 0.16 |
| 2 | 25% | 25 | >50000 | 0.23 |
| 3 | 25% | 25 | >50000 | 1.25 |
| 4 | 25% | 25 | 1538 | 0.18 |
| 5 | 25% | 25 | 2850 | 0.09 |
| 5 | 45% | 25 | 200 | 0.08 |
| 6 | 25% | 25 | >50000 | 0.10 |
| 6 | 45% | 25 | 510 | 0.08 |
| 7 | 25% | 25 | >50000 | 0.12 |
| 7 | 45% | 25 | 423 | 0.10 |
| 8 | 45% | 25 | 2393 | 0.53 |
| CE-A | 25% | 25 | 833 | 4.10 |
| CE-A | 45% | 25 | 63 | 2.30 |
| CE-B | 25% | 25 | 108 | 8.40 |
| CE-B | 45% | 25 | 13 | 2.80 |
| CE-C | 45% | 25 | 650 | 1.00 |

1) A membrane assembly for a liquid flow battery comprising:
an ion exchange membrane having a first surface and an opposed second surface;
a first microporous protection layer having a first surface and an opposed second surface; wherein the first surface of the ion exchange membrane is in contact with the first surface of the first microporous protection layer; and the first microporous protection layer comprises:
an ionic resin; and
at least one of an electrically conductive particulate and a non-electrically conductive particulate, wherein the ratio of the weight of the ionic resin to total weight of particulate is from about 1/99 to about 10/1.

2) The membrane assembly for a liquid flow battery of claim 1, further comprising a second microporous protection layer have a first surface and an opposed second surface; wherein the second surface of the ion exchange membrane is in contact with the first surface of the second microporous protection layer; and the second microporous protection layer comprises:
an ionic resin; and
at least one of an electrically conductive particulate and a non-electrically conductive particulate, wherein the ratio of the weight of the ionic resin to total weight of particulate is from about 1/99 to about 10/1.

3) The membrane assembly for a liquid flow battery of claim 1, wherein the ratio of the weight of the ionic resin to total weight of particulate is from about 1/3 to about 10/1 in the first microporous protection layer.

4) (canceled)

5) (canceled)

6) The membrane assembly for a liquid flow battery of claim 1, wherein the first microporous protection layer includes both an electrically conductive particulate and a non-electrically conductive particulate.

7) (canceled)

8) The membrane assembly for a liquid flow battery of claim 6, wherein the ratio of the weight of the electrically conductive particulate to the weight of the non-electrically conductive particulate is from about 1/4 to about 4/1.

9) The membrane assembly for a liquid flow battery of claim 6, wherein the non-electrically conductive particulate comprises a non-electrically conductive inorganic particulate.

10) The membrane assembly for a liquid flow battery of claim 9, wherein the non-electrically conductive inorganic particulate is at least one of silica, alumina, ceria, titania, and zirconia.

11) (canceled)

12) (canceled)

13) The membrane assembly for a liquid flow battery of claim 1, wherein the ionic resin is an anionic exchange resin.

14) An electrode assembly for a liquid flow battery comprising:
a porous electrode having a first surface and an opposed second surface;
a first microporous protection layer having a first surface and an opposed second surface; wherein the first surface of the porous electrode is proximate the second surface of the first microporous protection layer; and the first microporous protection layer comprises:
an ionic resin; and
at least one of an electrically conductive particulate and a non-electrically conductive particulate, wherein the ratio of the weight of the ionic resin to total weight of particulate is from about 1/99 to about 10/1.

15) The electrode assembly for a liquid flow battery of claim 14 wherein the ratio of the weight of the ionic resin to total weight of particulate is from about 1/3 to about 10/1.

16) (canceled)

17) (canceled)

18) The electrode assembly for a liquid flow battery of claim 14, wherein the first microporous protection layer includes both an electrically conductive particulate and a non-electrically conductive particulate.

19) The electrode assembly for a liquid flow battery of claim 18, wherein the ratio of the weight of the electrically conductive particulate to the weight of the non-electrically conductive particulate is from about 1/4 to about 4/1.

20) The electrode assembly for a liquid flow battery of claim 18, wherein the non-electrically conductive particulate comprises a non-electrically conductive inorganic particulate.

21) The electrode assembly for a liquid flow battery of claim 19, wherein the non-electrically conductive inorganic particulate is at least one of silica, alumina, titania and zirconia.

22) (canceled)

23) (canceled)

24) The electrode assembly for a liquid flow battery of claim 14, wherein the ionic resin is an anionic exchange resin

25) (canceled)

26) The electrode assembly for a liquid flow battery of claim 14, wherein the porous electrode is hydrophilic.

27) A membrane-electrode assembly for a liquid flow battery comprising:
an ion exchange membrane having a first surface and an opposed second surface;
a first and second microporous protection layer each having a first surface and an opposed second surface; wherein the first surface of the ion exchange membrane is in contact with the first surface of the first microporous protection layer and the second surface of the ion exchange membrane is in contact with the first surface of the second microporous protection layer; and the first and second first microporous protection layers comprise:
an ionic resin; and
at least one of an electrically conductive particulate and a non-electrically conductive particulate, wherein the ratio of the weight of the ionic resin to total weight of particulate is from about 1/99 to about 10/1; and
a first and second porous electrode each having a first surface and an opposed second surface; wherein the first surface of the first porous electrode is proximate to the second surface of the first microporous protection layer and the first surface of the second porous electrode is proximate to the second surface of the second microporous protection layer.

28) The membrane-electrode assembly for a liquid flow battery of claim 27, wherein the ratio of the weight of the ionic resin to total weight of particulate is from about 1/3 to about 10/1 in the first microporous protection layer, and, optionally, in the second microporous protection layer.

29) The membrane-electrode assembly for a liquid flow battery of claim 27, wherein the electrically conductive particulate and the non-electrically conductive particulate are each at least one of a particle, a flake and a dendrite.

30) (canceled)

31) The membrane-electrode assembly for a liquid flow battery of claim 27, wherein at least one of the first microporous protection layer and the second microporous protection layer include both an electrically conductive particulate and a non-electrically conductive particulate.

32) (canceled)

33) The membrane-assembly for a liquid flow battery of claim 31, wherein the ratio of the weight of the electrically conductive particulate to the weight of the non-electrically conductive particulate is from about 1/4 to about 4/1.

34) (canceled)

35) The membrane-electrode assembly for a liquid flow battery of claim 27, wherein the non-electrically conductive inorganic particulate is at least one of silica, alumina, titania and zirconia.

36) (canceled)

37) (canceled)

38) The electrode assembly for a liquid flow battery of claim 27, wherein the ionic resin is an anionic exchange resin.

39) (canceled)

40) An electrochemical cell for a liquid flow battery comprising a membrane assembly of claim 1.

41) (canceled)

42) (canceled)

43) A liquid flow battery comprising a membrane assembly of claim 1.

44) (canceled)

45) (canceled)
